(19) United States
(12) Patent Application Publication
(10) Pub. No.: US 2011/0264432 A1
(43) Pub. Date: Oct. 27, 2011

(54) SYSTEM AND METHOD FOR MODELLING A MOLECULE WITH A GRAPH

(75) Inventors: Robert Penner, Aarhus C (DK); Jorgen Ellegaard Andersen, Hojbjerg (DK); Michael Knudsen, Randers (DK); Carsten Wiuf, Aarhus N (DK)

(73) Assignee: Aarhus Universitet, Aarhus C (DK)

(21) Appl. No.: 13/002,092

(22) PCT Filed: Jul. 1, 2009
(86) PCT No.: PCT/DK2009/050155

§ 371 Date: Jul. 14, 2011

Related U.S. Application Data
(60) Provisional application No. 61/077,277, filed on Jul. 1, 2008.

(30) Foreign Application Priority Data
Jan. 17, 2008 (DK) PA 2008 01009

(51) Int. Cl. G06G 7/58; G06G 7/60

(52) U.S. Cl. 703/11

(57) ABSTRACT

Modelling a molecule by means of a graph, said graph comprising vertices and edges, each edge having a specific type, and said graph having cyclic orderings on the half-edges about at least one of the vertices, said system comprising means for determining the cyclic orderings on the half-edges about said at least one vertex by means of the spatial coordinates of the constituent atoms of the molecule, and means for determining the type of each edge of the graph by means of the relative spatial location of the constituent atoms of the molecule. Thereby automatic classification, comparison, specification, analysis and/or prediction of molecular structures can be provided because these molecular structures are represented by explicit combinatorial objects, and descriptors can be derived from the graph constructed in this manner. The descriptors are automatically computable from molecular databases, such as PDB or CATH, with no qualitative human intervention or subjective criteria. The invention can be applied to macromolecular structures such as proteins, protein globules, ligands, polymers, nucleotides, nucleic acids, RNA and DNA.

The present invention relates to modelling of molecules, such as macromolecules like protein molecules and protein globules, which allows for efficient classification, comparison, specification, analysis and/or prediction of three-dimensional molecular and macromolecular structures.

### BACKGROUND

Three-dimensional macromolecular structures can be described by the specification of the spatial coordinates of the constituent atoms. A key example is given by the Protein Data Bank (PDB), which enumerates the known three-dimensional protein structures which have been experimentally determined by nuclear magnetic resonance or X-ray crystallography techniques. Specific entries in the PDB consist of the so-called primary structure of a protein molecule given by the sequence of amino and/or imino acid residues along the backbone, together with the spatial coordinates of the atoms comprising the backbone and the residues. Each entry of the PDB thus contains massive data, and it is a significant problem how to classify or compare entries in the PDB for example by computing and comparing summary statistics. The summary statistics of known utility include the determination of so-called alpha helices (α-helices) and beta strands (β-strands) and their organization into a number of standard architectural motifs such as beta propellers, alpha beta alpha sandwiches, and so on. This determination of architectural type is provided manually without any precise definitions. Another key example is the CATH databank derived from the PDB, which organizes protein domains or globules according to Class (alpha, beta, mixed alpha beta and sparse alpha beta), Architecture (consisting of 40 standard motifs), Topology (a refinement of architecture that includes position along the backbone) and Homology (a refinement of topology that includes similarity of primary structure).

A key ingredient of the present invention is a combinatorial object called a “fatgraph”, which was first defined by R. C. Penner in Perturbative series and the moduli space of Riemann surfaces, Journal of Differential Geometry 27 (1988), 35-53. A fatgraph determines a corresponding surface with boundary. Fatgraphs have been employed in a number of computations in geometry and in the string theory of high-energy physics. Fatgraphs have also been used to describe a model for RNA and other macromolecules in R. C. Penner and M. S. Waterman: Spaces of RNA secondary structures, Advances in Mathematics, 101 (1993), 31-49. This RNA model differs significantly from the present invention since the underlying graphs pertinent to RNA structure are trees rather than the more general graphs discussed here for example.

Automatically computable summary statistics for protein and other macromolecular structures have been proposed, for example, in the international Patent Cooperation Treaty filings WO 97/01144, WO 01/33438, WO 98/59306, WO 02/88662, WO 84/02599, WO 84/01846, WO 01/35255, WO 98/47089 and in the US filings US 2006/0253260, U.S. Pat. No. 5,787,279, U.S. Pat. No. 7,315,786 and US 2007/0118296. Major problems with these known systems and methods are their unproved utility and/or lack of stringency.

### SUMMARY OF THE INVENTION

An object of the invention is to provide a model representing a molecule.

This is achieved by a method for modelling a molecule by means of a graph, said graph comprising vertices and edges, each edge having a specific type, and said graph having cyclic orderings on the half-edges about at least one of the vertices, said method comprising the steps of:
obtain the spatial coordinates and the relative spatial locations of the constituent atoms of the molecule,
determine cyclic orderings on the half-edges about said at least one vertex by means of the spatial coordinates of the constituent atoms of the molecule,
determine the type of each edge of the graph by means of the relative spatial location of the constituent atoms of the molecule, and
model the molecule by the resulting graph.

The invention further relates to a system for modelling a molecule by means of a graph, said graph comprising vertices and edges, each edge having a specific type, and said graph having cyclic orderings on the half-edges about at least one of the vertices, said system comprising:
means for obtaining the spatial coordinates and the relative spatial location of the constituent atoms of the molecule,
means for determining cyclic orderings on the half-edges about said at least one vertex by means of the spatial coordinates of the constituent atoms of the molecule,
means for determining the type of each edge of the graph by means of the relative spatial location of the constituent atoms of the molecule, and
means for modelling the molecule by the resulting graph.

In a preferred embodiment of the invention, the graph modelling a molecule is a “fatgraph”. A fatgraph is a graph in the usual sense of the term together with the further specification of a cyclic ordering on the half-edges about each vertex, i.e., in the following, a fatgraph is a graph with a cyclic ordering on the half-edges about each vertex.

By the system and method according to the invention, any molecule can be represented by a graph, and more specifically by a fatgraph, if the spatial coordinates and the relative spatial locations of the atoms in the molecule are known. This is the case for a great many of molecules in the world. For example, X-ray crystallography can provide this information.

### DETAILED DESCRIPTION OF THE INVENTION

By the system and method according to the invention, automatic classification, comparison, specification, analysis and/or prediction of molecular structures can be provided because these molecular structures are represented by explicit combinatorial objects, and descriptors of the molecular structure can be derived from the graph constructed in this manner. The combinatorial objects representing these molecular structures can subsequently be stored, processed, and manipulated digitally. A key novelty of the present invention is that these descriptors are automatically computable from molecular databases, such as PDB or CATH, with no qualitative human intervention or subjective criteria.

In one embodiment of the present invention, a fatgraph is associated to any three-dimensional molecule. In a particular embodiment of the invention, a fatgraph is associated to any protein molecule or protein globule structure, preferably together with a labelling of certain edges of the fatgraph by its residues. To each peptide unit of a protein or protein globule is associated a standard building block for a fatgraph as illustrated in FIG. 1, where the indicated “sites” correspond to sequential oxygen and hydrogen atoms of the peptide unit for amino acids and have the slightly different interpretation for imino acids illustrated in FIG. 2. The label indicates which residue occurs along the backbone. These building blocks are assembled into a model for the backbone, where the relative spatial coordinates of constituent atoms and the nearby residue types are used to determine the sequential arrangement of these building blocks as illustrated in FIGS. 3-4. The fatgraph associated to the protein molecule or protein globule is completed by adding an edge connecting pairs of sites for each hydrogen bond along the backbone. This is illustrated in FIG. 5.

From a constructed fatgraph, there are a number of numerical and other properties that can be defined including but not limited to: the genus of the corresponding surface and its number of boundary components; the sequence of lengths, as edge-paths or as number of peptide units traversed, of its boundary components; the average length of its boundary components; the lengths or average lengths of boundary components passing through each residue type. The most refined property is the isomorphism class itself of the labelled fatgraph constructed, and this too can conveniently be described as a data type on the computer. Weaker properties also arise by considering notions of approximate identity among fatgraphs.

Properties of graphs (and thereby properties of fatgraphs) may also be termed invariants. When a fatgraph has been associated with a molecule, such as a protein, the properties of the fatgraph can be used to provide a number of protein descriptors, which for example can be used to predict protein functional families. Thus, properties and invariants of fatgraphs in a mathematical terminology give rise to descriptors in a biochemical terminology. There might even be a mix of terminologies when protein descriptors are themselves termed invariants.

In protein science, the purview of the invention includes the classification, comparison, specification, analysis, and prediction of protein molecule or protein globule structures based on descriptors derived from the labelled fatgraph constructed in this manner. A key novelty of the present invention is that these descriptors are automatically computable for instance from PDB or CATH with no qualitative human intervention or subjective criteria, and another key novelty is the dependence of the descriptors upon a fatgraph.

In a preferred embodiment of the invention, the input to the model is the three-dimensional structure of a molecule given by spatial coordinates of the constituent atoms and those pairs of oxygen and hydrogen atoms along the backbone which are bonded as well as its primary structure of residues occurring along the backbone. In some cases, the derived conformational angles are also provided as input to the model.

Most molecules can be divided into smaller parts, i.e., sub-molecules. A molecule can thereby be represented by a plurality of sub-molecules, such as a concatenation of sub-molecules in a linear polymer.

In a preferred embodiment of the invention, the graph comprises a sequence of subgraph building blocks, each subgraph building block representing a sub-molecule, e.g., the sequence of subgraph building blocks represents the concatenation of sub-molecules. A protein is for example a concatenation of peptide units, i.e., the peptide units are sub-molecules of the protein.

In a preferred embodiment of the invention, each subgraph building block comprises a horizontal line segment and a vertical line segment attached on each side of the horizontal line segment, each horizontal and vertical line segment representing a chemical bond between constituent atoms of the molecule.

In a further aspect of the invention, the method comprises
correlate the position of the first subgraph building block with the spatial coordinates of constituent atoms of the first sub-molecule,
connect the subgraph building blocks in series based upon the relative spatial coordinates of constituent atoms comprising the sub-molecules, and
provide edges to the graph by connecting segments of the subgraph building blocks, each such edge corresponding to a chemical bond of the molecule.

In yet a further aspect of the invention, each subgraph building block comprises a horizontal line segment representing a carbon—nitrogen bond and a vertical line segment attached on each side of the horizontal line segment, the first and leftmost vertical line segment representing an oxygen site. The method according to the invention furthermore preferably comprises the further specifications:
correlate the position of the first and leftmost vertical line segment of each subgraph building block with the orientation of the oxygen atom on the backbone of the sub-molecule,
connect the horizontal segments of the subgraph building blocks in series based upon the relative spatial coordinates of constituent atoms comprising the sub-molecules, and
provide edges to the graph by connecting vertical segments, each edge corresponding to a hydrogen bond along the backbone of the molecule.

In various embodiments of the invention, the molecule can be a macromolecule, a protein, a protein globule, a ligand, a polymer and/or a linear polymer. A macromolecule is a molecule comprising tens or even hundreds or thousands of atoms, possibly even billions of atoms. Nucleotides and nucleic acids can also be modelled by a graph by the method according to the invention. The method can also be applied to RNA, messenger RNA (mRNA), transfer RNA (tRNA) and ribosomal RNA (rRNA), to DNA molecules and to fragments of DNA.

In one aspect of the invention, the macromolecule is a protein, and the sequence of the subgraph building blocks is determined by the primary structure of the protein. Furthermore, the relative spatial coordinates of constituent atoms and/or the conformational angles and/or the hydrogen bonding along the backbone of the protein are preferably determined by and/or inferred from the tertiary structure of the protein. In a further aspect, a labelling by amino acid residues is provided, said labelling based upon the primary structure of the protein of certain edges of the graph.

In one aspect of the invention, the subgraph building blocks represent peptide units. This is for example the case when modelling proteins.

In a preferred embodiment of the invention, numerical and/or other descriptors of the molecule are provided from properties of the corresponding graph. The corresponding graph is the graph or fatgraph that is the result of modelling the molecule with a graph or fatgraph according to the method of the invention.

In yet another aspect of the invention, it can be determined whether two molecules are similar based upon equality and/or similarity of the corresponding graphs and/or descriptors.

Furthermore, a library of structures for a family of molecules is preferably provided, based upon the corresponding graphs and/or descriptors.

In another aspect of the invention, families of molecules are provided based upon equality and/or similarity of the corresponding graphs. Furthermore, a classification of a subject molecule within a family is preferably provided. The biological function of a molecule based upon the corresponding graph is also preferably provided by the method according to the invention.

In a further aspect of the invention, the melting and/or folding pathway of a molecule is modelled and/or predicted based upon the corresponding graph. Secondary and/or tertiary structure of a molecule from its primary structure may also be predicted. This prediction is preferably based upon libraries and/or descriptors provided from the corresponding graphs.

In yet another aspect of the invention, the external surface and/or the active sites of a molecule from its primary structure is predicted, based upon libraries and/or descriptors provided from the corresponding graphs.

In another aspect the invention relates a computer program product including a computer readable medium, said computer readable medium having a computer program stored thereon, said program for modelling a molecule by means of a graph comprising program code for conducting any of the steps of any of the abovementioned methods.

Further, the invention relates to a system for modelling a molecule by means of a graph, said system including computer readable memory having one or more computer instructions stored thereon, said instructions comprising instructions for conducting any of the steps of any of the abovementioned methods.

Even further, the invention relates to a computer program product having a computer readable medium, said computer program product providing a system for modelling a molecule by means of a graph, said graph comprising vertices and edges, each edge having a specific type, and said graph having cyclic orderings on the half-edges about at least one of the vertices, and said computer program product comprising means for carrying out any of the steps of the abovementioned methods.

When modelling a macromolecule according to the present invention, the following steps can be provided:
read the three-dimensional structure of a macromolecule,
arrange the sequential composition of the subgraph building blocks based on the spatial coordinates of constituent atoms and type of sub-molecule and the possible additional labelling of certain edges by sub-molecules based on the primary structure,
determination of the graph itself from the additional information of bonding of sites along the backbone,
calculation of numerical and/or other descriptors from the labelled graph, and
classification, comparison, specification, analysis, and prediction of macromolecular structures derived from these descriptors.

In the case of modelling a protein or protein globule by means of a fatgraph, the following steps can be provided:
read the three-dimensional structure of a protein or protein globule and the sequence of residues along the backbone,
arrange the sequential composition of the fatgraph building blocks based on the spatial coordinates of constituent atoms and residue types and the possible additional labelling of certain edges by residues based on the primary structure,
determination of the fatgraph itself from the additional information of hydrogen bonding of sites along the backbone,
calculation of numerical or other invariants and/or descriptors from the labelled fatgraph, and
classification, comparison, specification, analysis, and prediction of protein or protein globule structures derived from these invariants and/or descriptors.

Peptide Modelling

A further object of the invention is to provide a mathematical representation of a peptide unit (or just “peptide”).

This is achieved by a system and a method for modelling a peptide unit, said model comprising a horizontal line segment representing the carbon—nitrogen bond and a vertical line segment attached on each side of the horizontal line segment, the first and leftmost vertical line segment representing an oxygen site.

In a preferred embodiment of the invention, the second and rightmost vertical line segment represents a hydrogen site.

In case the peptide unit is Proline, the second and rightmost vertical line segment preferably represents a carbon site.

In a preferred embodiment of the invention, the relative position of the first and leftmost vertical line segment corresponds to the location of the oxygen atom on the backbone of the peptide unit when traversed in its natural orientation from the nitrogen end to the carbon end.

In a further aspect the invention relates to a computer program product having a computer readable medium, said computer program product providing a system for modelling a peptide unit, said model comprising a horizontal line segment representing the carbon—nitrogen bond and a vertical line segment attached on each side of the horizontal line segment, the first and leftmost vertical line segment representing an oxygen site, and said computer program product comprising means for carrying out any of the steps of the abovementioned methods.

### DRAWINGS

FIG. 1 illustrates modelling of a peptide unit with a subgraph building block.

FIG. 2 illustrates modelling of a peptide unit preceding a cis-Proline with a subgraph building block.

FIG. 3 illustrates the connection of subgraph building blocks along the backbone of a protein

FIG. 4 illustrates the two standard conformational angles φᵢ and ψᵢ.

FIG. 5 illustrates the adding of edges to the subgraph building blocks to represent the hydrogen bonds along the backbone of a protein.

FIG. 6 shows orientable surfaces on the left and non-orientable surfaces on the right.

FIG. 7 illustrates the construction of a surface F(G) with boundary from a fatgraph G, for two fatgraphs G₁ (on the left) and G₂ (on the right).

FIG. 8 illustrates a twisted fatgraph G₃ (to the left), with the stubs labelled 1 through 9, and the corresponding orientation double cover to the right.

FIG. 9 is a Ramachandran plot of cutpoints for the entire CATH database, i.e., the plot of pairs of conformational angles (φᵢ, ψᵢ).

FIG. 10 shows the manifestation of alpha helices and beta strands in the fatgraph model.

FIG. 11 is a flow chart for one embodiment of the invention.

FIGS. 12-19 show calculations of the modified genus g* and the number r of boundary components for various families of the CATH databank.

### BACKGROUND AND DEFINITIONS FOR SURFACES, GRAPHS AND FATGRAPHS

A graph in the usual sense of the term comprises vertices (also termed points and nodes) connected by edges (also termed lines). A graph is typically illustrated in diagrammatic form as a set of dots (for the points, vertices, or nodes), joined by curves (for the lines or edges). Cutting an edge of the graph in half produces two segments which are termed half-edges. Graphs with labels attached to edges and/or vertices are generally designated as labelled. Correspondingly, graphs in which vertices and edges are indistinguishable are called unlabelled.

A fatgraph is a graph in the usual sense of the term together with the further specification of a cyclic ordering on the half-edges about each vertex.

Example: There are 6 orderings on a set {a,b,c} with three elements:

(a,b,c),(a,c,b),(b,a,c),(b,c,a),(c,a,b),(c,b,a)

There are only two cyclic orderings on the set {a,b,c}:

(a,b,c) and (c,b,a)

since a “cyclic permutation” of (a,b,c) provides:

(a,b,c),(b,c,a),(c,a,b),

and a “cyclic permutation” of (c,b,a) provides

(c,b,a),(b,a,c),(a,c,b).

These give all the orderings, and (a,b,c) and (c,b,a) are not related by cyclic permutation. Finally, consider a graph. For each vertex, there is a finite collection of half-edges incident on it, and a ‘cyclic ordering on the half-edges about the vertex’ is just that: a cyclic ordering on the half-edges. In this example, at a 3-valent vertex of a graph, there are exactly two possible different cyclic orderings.

A surface is a two-dimensional manifold possibly with boundary. Surfaces will always have non-empty boundary and be embedded as subsets of three-dimensional space. The surface F is said to be connected if any two points of F can be joined by a continuous path in F, and F in three-space is compact provided F contains all limit points of convergent subsequences in F, and there is some three-dimensional ball of finite radius in three-space containing F. Two surfaces are homeomorphic if there is a continuous bijection between them whose inverse is also continuous. The surface F is said to be orientable if it does not contain a subsurface which is homeomorphic to a Möbius band, and otherwise F is said to be non-orientable.

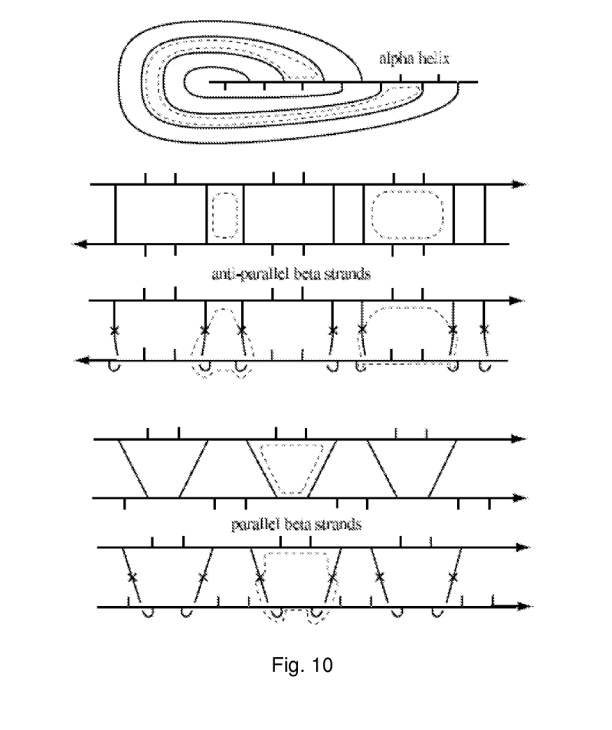

It is a classical result in mathematics that the homeomorphism type of any compact and connected surface F with boundary, is uniquely determined by the specification of whether it is orientable or non-orientable together with its genus g=g(F) and its number r=r(F) of boundary components. FIG. 6 illustrates surfaces of genus g with r boundary components with orientable surfaces indicated on the left and non-orientable surfaces on the right.

Another standard numerical invariant of a surface F is its Euler characteristic X(F) defined to be the number of faces minus the number of edges plus the number of vertices in any decomposition of F into finitely many embedded triangles, where any two such triangles meet along a common face if at all. It is again a classical fact that the relationship between the genus g, number r of boundary components, and Euler characteristic X of a compact and connected surface F is given by X=2−2g−r if F is orientable and X=2−g−r if F is non-orientable.

Owing to the disparity in these two cases, it is useful to define the modified genus of F to be g*=g, if F is orientable and g*=g/2, if F is non-orientable, so the formula X=2−2g*−r holds in any case.

One useful way to describe an orientable surface F with boundary is with an untwisted fatgraph. Two untwisted fatgraphs are said to be equivalent if there is an isomorphism of underlying graphs which respects the cyclic orderings.

A picture of this extra structure can be drawn with the planar projection of a graph embedded in space by drawing in the plane a collection of vertices of various valencies, i.e., the number of incident stubs, where the cyclic ordering is the counter-clockwise one in the plane, and any crossings of the projections of edges of the graph are arbitrarily resolved into over- or under-crossings.

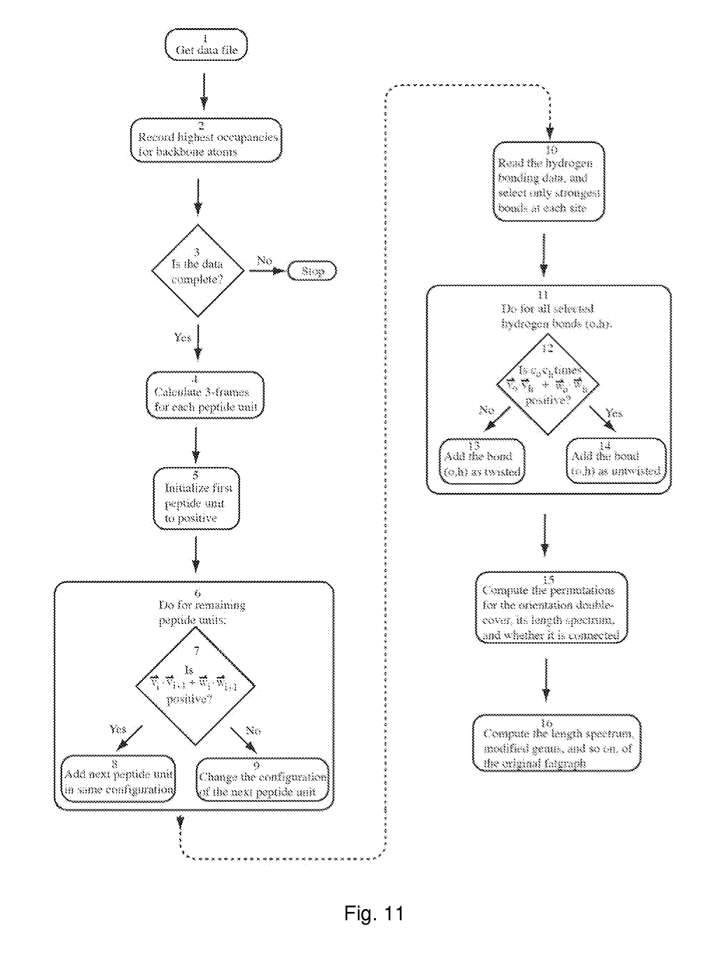

An example of two untwisted fatgraphs G₁, G₂ based on the same underlying graph is illustrated in FIG. 7, where the additional notation and structure will be explained presently. FIG. 7 is an example of two fattenings on the same underlying graph. Each of the two untwisted fatgraphs G₁, G₂, which are illustrated by heavy lines, has three vertices of valence three, and a neighbourhood of the vertex set in the plane of projection is indicated by solid lines. The neighbourhood of a vertex of valence k has k≧1 many stubs, which are labelled 1 through 9 for each fatgraph in FIG. 7, and the label of a stub is drawn preceding the stub itself in the counter-clockwise cyclic ordering in the plane of projection. A small semantical point is that pairs of stubs may combine to form edges of the untwisted fatgraph, but not every stub necessarily occurs as half an edge; for example, the stubs labelled 1 on the bottom in FIG. 7 do not arise as half an edge in either G₁ or G₂ though each occurs in the cyclic ordering on half-edges about the bottom-most vertices in the figure.

The genus of F(G) is not the classical genus of the underlying graph, i.e., the least genus surface in which the underlying graph can be embedded. Rather, the classical genus of the underlying graph is the least genus of a surface F(G) arising from all fattenings on the underlying graph, i.e., all possible cyclic orderings on the half-edges about its vertices.

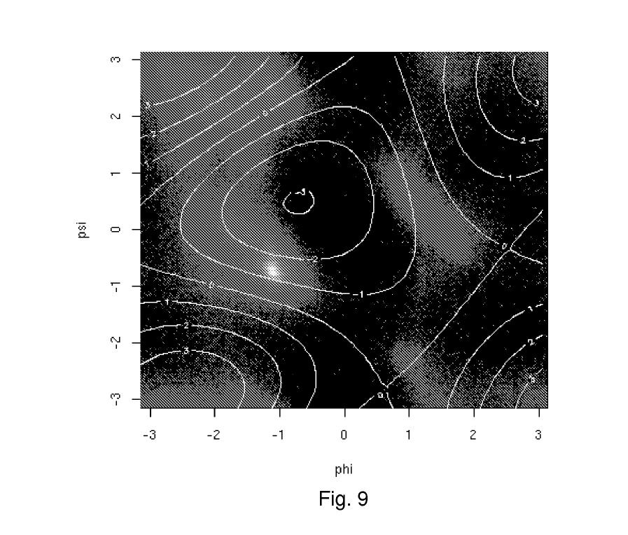

An untwisted fatgraph admits a useful description as the following data type, employing the standard notation (i₁, i₂, . . . , iₖ) for the permutation i₁→i₂→ . . . →iₖ→i₁ where i₁, . . . , iₖ are distinct elements of the set {1, . . . , N} for some k>1 and N>1. Consider a pair of permutations σ, T on 1, . . . , N, where T is the composition of a collection of disjoint transpositions (tᵢ¹, tᵢ²), for i=1, . . . , M≦N, and a is comprised of a collection of vₖ>0 disjoint cycles of length k≧1. Start with a “standard” collection of vₖ k-valent vertices in the plane, where the cycles of σ correspond to the vertices and are conveniently numbered as in FIG. 5 with σ=(1,2,3)(4,5,6)(7,8,9) for both G₁ and G₂, and adjoin one edge connecting stubs tᵢ¹ and tᵢ² for each transposition (tᵢ¹, tᵢ²) in σ. For instance, with σ as before, the fatgraph G₁ is described by T₁=(2,8) (3,6) (4,7) (5,9), and the fatgraph G₂ is described by T₂=(2,8)(3,6)(4,9)(5,7).

Furthermore, two untwisted fatgraphs (σᵢ, Tᵢ), for i=1,2, are isomorphic (i.e., there is an isomorphism of underlying graphs respecting the cyclic orderings) if and only if there is a permutation μ on N symbols so that μ⁻¹σ₁μ=σ₂, and μ⁻¹T₁μ=T₂; isomorphic fatgraphs give surfaces with the same genus and number of boundary components, but many distinct fatgraphs give rise to identical surfaces.

There is a useful direct relationship between the untwisted fatgraph data type as a pair of permutations and the number r of boundary components as follows. Given a fatgraph described by a pair of permutations σ, T, consider the permutation ρ=σ∘T given by their composition. The invariant r is the number of cycles of the permutation ρ. For instance in the ongoing pair of examples, ρ₁=σ∘T₁=(5,7) (3,4,8) (1,2,9,6) has r=3 cycles while ρ₂=σ∘T₂=(1,2,9,5,8,3,4,7,6) has only r=1 cycle.

There is also the following method to determine whether an untwisted fatgraph is connected.

Algorithm 1: Suppose that σ, T are permutations on {1, . . . , N}, where T is an involution. Let X be the subset of {1, . . . , N} in the cycle of ρ=σ∘T containing 1.

(*) If X={1, . . . , N}, then G is connected, and the algorithm terminates.

If X≠{1, . . . , N}, then consider the existence of at least index i ∈ {1, . . . , N}−X so that T (i) ∈ X. If there is no such index i, then G is not connected, and the algorithm terminates. If there is such an index i, then update X by adding to it the subset of {1, . . . , N} in the cycle of ρ containing i. Go to (*).

In summary, an untwisted fatgraph G with v vertices and e edges determines a surface F(G) of genus g with r>1 boundary components, which has Euler characteristic 2−2g−r=v−e. Furthermore, an untwisted fatgraph as a data type is easily stored as a pair of permutations (σ, T), and the number of cycles of the composition ρ=σ∘T is the number r of boundary components.

Moreover, the equivalence class of an untwisted fatgraph G is unequivocally determined by a pair σ, T of permutations on the same set, where T is an involution. Two such pairs σ, T and σ′, T′ determine equivalent untwisted fatgraphs if and only if there is a permutation simultaneously conjugating σ to σ′ and T to T′. The Euler characteristic X of the orientable surface F(G) can be determined directly as the number of disjoint cycles comprising σ minus the number of disjoint transpositions comprising T. The number r of boundary components of F(G) can be directly computed as the number of disjoint cycles comprising ρ=σ∘T. The above-mentioned Algorithm 1 gives a method of determining whether F(G) is connected, and if F(G) is connected, then the genus of F(G) is given by g=(2−x−r)/2.

Twisted Fatgraphs

In order to analogously describe possibly non-orientable surfaces, consider more generally a fatgraph which is an untwisted fatgraph as before but now with two types of edges, twisted and untwisted, where the latter type corresponds to the edges considered before. Two fatgraphs are strongly equivalent if there is an isomorphism of underlying graphs respecting cyclic orderings and preserving the type, twisted or untwisted, of each edge.

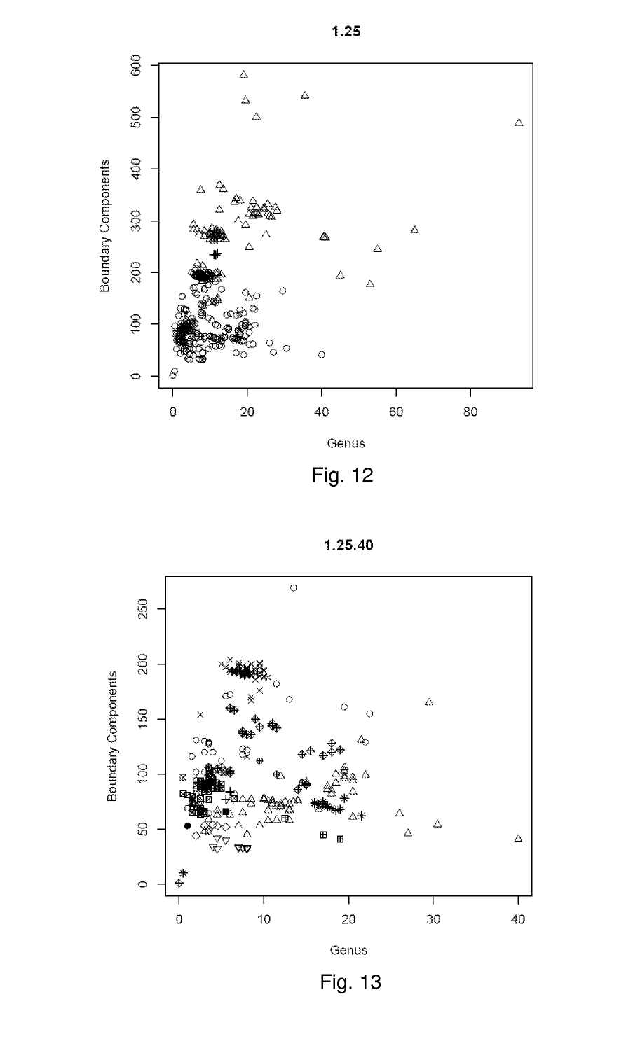

Referring to FIG. 8, a fatgraph has been drawn with a planar projection by arranging vertices in the plane so that the cyclic orderings correspond to the counter-clockwise orientation in the plane and whose pairs of stubs, corresponding to half-edges of a common edge, are connected. This is as before, but now, any twisted edges are distinguished by putting the icon “x” on each of them. An example is illustrated on the left in FIG. 8, where the stubs are again labelled 1 through 9, and the edge connecting stubs 4 and 7 is the unique twisted edge.

Fix the planar projection as above of a fatgraph G, and consider a pair of stubs comprising an edge of the underlying graph. If the edge is untwisted, attach a band connecting them and respecting the orientation of the plane as before and as illustrated in FIG. 8 with dotted lines. If the edge is twisted, attach a band connecting them that reverses the orientation of the plane in contrast to untwisted fatgraphs and as illustrated in FIG. 8 with dotted lines. This produces a surface F(G) with boundary, where F(G) contains G. In particular in the example G₃ illustrated on the left in FIG. 8, the compact and connected surface F(G) is non-orientable, has r=2 boundary components, and again has Euler characteristic X=−1 by inspection and hence has genus g=1 and modified genus g*=½.

If G has v vertices and e edges, then the Euler characteristic is given by X(F(G))=v−e and so depends only on the graph underlying G. If two fatgraphs G, G′ are strongly equivalent, then there is a homeomorphism of F(G) with F(G′) taking G⊂F(G) to G′⊂F(G).

Two fatgraphs G, G′ are equivalent if there is a homeomorphism from F(G) to F(G′) mapping G⊂F(G) to G′⊂F(G′), so strong equivalence implies equivalence. The converse is not true.

Given a fatgraph G, choose an enumeration of its stubs by {1, . . . , N}, for some N≧1. Define a permutation a on this set as before as the product of disjoint cycles, one k-cycle (i₁, . . . , iₖ) for each vertex of G of valence k with incident stubs enumerated in their cyclic order by i₁, . . . , iₖ. Define two further permutations Tᵤ (and Tₜ respectively) on this same set, where Tᵤ (and Tₜ) is the product of disjoint transpositions (j, k), one such transposition for each pair of stubs enumerated by j, k comprising an untwisted (and twisted) edge of G.

For any triple of permutations σ, Tᵤ, Tᵣ on {1, . . . , N}, where Tᵤ and Tₜ are disjoint involutions, there is a unique strong equivalence class of fatgraph G with stubs enumerated by this same set so that the above-mentioned produces σ, Tᵤ, Tₜ from G. Two such triples σ, Tᵤ, Tᵣ and σ′, T′ᵤ, T′ₜ determine strongly equivalent fatgraphs if and only if there is permutation μ on {1, . . . , N} so that μ∘σ∘μ⁻¹=σ′, μ∘Tᵤ∘μ⁻¹=T′ᵤ and μ∘Tₜ∘μ⁻¹=T′ₜ

An example is illustrated on the left in FIG. 8, where the fatgraph G₃ is determined by the same permutation σ=(1, 2, 3)(4, 5, 6)(7, 8, 9) as for G₁ and G₂ in FIG. 7, but now with the disjoint involutions Tᵤ=(2, 8)(3, 6)(5, 9) and Tₜ=(4, 7).

It is not true that the boundary components of F(G) are given by a simple composition of σ with Tᵤ and Tₜ as in the last assertion for untwisted fatgraphs.

Algorithm 2: Given a fatgraph G described by the triple σ, Tᵤ, Tₜ of permutations on the set {1, . . . , N}, construct a new set of indices { 1̅, . . . , N̅}. Construct from σ a new permutation σ̅, where there is one k-cycle (īₖ, . . . , ī₁) in σ̅ a for each k-cycle (i₁, . . . , iₖ) in σ. Construct from Tᵤ a new permutation τ̅ᵤ, where there is one transposition ( j̅, k̅) in τ̅ᵤ for each transposition (j, k) in Tᵤ, and construct yet another new permutation τ̅ₜ from Tₜ, where there are two transpositions ( j̅, k) and (j, k̅) in τ̅ₜ for each transposition (j, k) in Tₜ. Finally, define permutations on {1, . . . , N}∪{ 1̅, . . . , N̅} by

σ′=σ∘ σ̅

τ′=τᵤ∘ τ̅ᵤ∘\tilde{τ}ₜ

where the order of composition on the right-hand side is immaterial since in each case it is the composition of disjoint permutations.

The orientation double cover of a surface F is the oriented surface \tilde{F} together with the continuous map p: \tilde{F}→F so that for every point x ∈ F there is a disk neighbourhood U of x in F, where p⁻¹(U) consists of two components on each of which p restricts to a homeomorphism and where the further restrictions of p to the boundary circles of these two components give both possible orientations of the boundary circle of U. Such a covering p: \tilde{F}→F always exists, and its properties uniquely determine \tilde{F} up to homeomorphism and p up to its natural equivalence. Furthermore, it is not hard to see that provided F is connected, F is non-orientable if and only if \tilde{F} is connected, and a closed curve in F lifts to a closed curve in \tilde{F} if and only if a neighbourhood of it in F is i homeomorphic to an annulus (as opposed to homeomorphic to a Möbius band).

Given a triple σ, Tᵤ, Tₜ describing a fatgraph G, let σ′, T′ be the permutations supplied by the above-mentioned Algorithm 2, which describe the untwisted fatgraph G′. The orientable surface F(G′) is the orientation double cover of F(G). In particular provided F(G) is connected, F(G′) is connected if and only if F(G) is non-orientable. Furthermore, there is a one-to-one correspondence between the boundary components of F(G′) and the orientations on the boundary components of F(G), i.e., F(G′) has twice as many boundary components as F(G).

In order to finally describe the boundary components of F(G) for a fatgraph G, a small technical point must be addressed. Namely, given a planar projection of a fatgraph, put the label of each stub preceding the stub in the counter-clockwise sense in the plane of projection. Since the notion of clockwise and counter-clockwise depends upon orientation, there is the following algorithm to compute the boundary components which addresses this:

Given a triple σ, Tᵤ, Tₜ describing a fatgraph G, let σ′, T′ be the previously mentioned permutations which describe the untwisted fatgraph G′. The boundary components of F(G′) correspond to the cycles of ρ′=σ′∘T′. The boundary components of F(G) can be recovered from those of F(G′) by the following modification: Suppose that (i₁, . . . , iₖ) is a cycle of ρ′, where each i₁ ∈{1, . . . , N}∪{ 1̅, . . . , N̅}, for l=1, . . . , k, and define j₁=i₁, if i₁ ∈ {1, . . . , N} and j₁= (̅σ̅′̅)̅⁻̅¹̅(̅i̅₁̅)̅ (̅σ̅′̅)̅⁻̅¹̅(̅i̅₁̅)̅, i₁ ∈ { 1̅, . . . , N̅}, where i̅=i for any index i. They cycle (j₁, . . . , jₖ) of indices corresponds to a boundary component of F(G).

To give an example, return to consideration of the fatgraph G₃ with its single twisted edge illustrated on the left in FIG. 8. The permutations for the orientation double cover are given by

σ′=(1, 2, 3)(4, 5, 6)(7, 8, 9)( 3̅, 2̅, 1̅)( 6̅, 5̅, 4̅)( 9̅, 8̅, 7̅),

τ′=(2, 8)(3, 6)(5, 9)( 2̅, 8̅)( 3̅, 6̅)( 5̅, 9̅)(4, 7̅)( 4̅, 7),

The untwisted fatgraph G′₃ corresponding to σ′, T′, illustrated on the right in FIG. 8, and it is connected reflecting the fact that F(G) is non-orientable. The cycles of ρ′=σ′∘T′ are given by (1, 2, 9, 6), ( 1̅, 3̅, 5̅, 8̅), and ( 2̅, 7̅, 5, 7, 6̅), (3, 4, 9̅, 4̅, 8) corresponding to the boundary cycles of G′, and the cycles which are modified according to the algorithm are finally given by (1, 2, 9, 6), (2, 1, 6, 9) and (3, 8, 5, 7, 4), (3, 4, 7, 5, 8), each pair corresponding to the two orientations of a single boundary component of F(G).

There is again a simple variant of a previous algorithm to determine whether F(G) is connected in terms of its boundary cycles as follows:

Algorithm 3: Suppose that σ, Tᵤ, Tₜ are permutations on {1, . . . , N}, where Tᵤ and Tₜ are disjoint involutions, with corresponding fatgraph G. The boundary cycles of F(G) are determined by a previous algorithm. Let X be the subset of {1, . . . , N} in the boundary cycle of F(G) containing 1.

(*) If X={1, . . . , N}, then G is connected, and the algorithm terminates.

If X≠{1, . . . , N}, then consider the existence of a least index i ∈ {1, . . . , N}−X so that Tᵤ∘Tₜ(i) ∈ X. If there is no such index i, then G is not connected, and the algorithm terminates. If there is such an index i, then update X by adding to it the subset of {1, . . . , N} in the boundary cycle of F(G) containing i. Go to (*).

Finally, the relationship between equivalence and strong equivalence of fatgraphs is as follows. Let G be a general fatgraph regarded as an untwisted fatgraph together with a labelling of its edges by the two colors twisted and untwisted, which can be regarded as taking values in Z/2, the integers modulo two. Given a vertex u of G, define the vertex flip of G at u by reversing the cyclic ordering on stubs incident on u and changing the type, twisted or untwisted, of each edge incident on u, and let Gᵤ denote the fatgraph arising from G by flipping the vertex u. In effect for calculations, a vertex flip may be provided by reversing the cyclic ordering on incident stubs, each one marked by an additional icon x, and erasing pairs of these icons on a common edge.

Two fatgraphs G and G′ are equivalent if and only if there is a third fatgraph G″ which arises from G by a finite sequence of vertex flips so that G′ and G″ are strongly equivalent. Indeed, strong equivalence implies equivalence as was mentioned before.

For the converse, fix a fatgraph G with v vertices and e edges, and choose a maximal tree T of G. There are 1−X(G)=1−v+e edges in G−T since T may be collapsed to a point without changing v−e, which is therefore the Euler characteristic of the collapsed graph comprised of a single vertex and one edge for each edge of G−T. There is a composition of flips of vertices in G that results in a fatgraph with any specified twisting on the edges in T. To see this, consider the collection of all functions from the set of edges of G to Z/2, a set that evidently has cardinality 2^{e}. Vertex flips act on this set of functions in the natural way, where the flip of a vertex changes the value of such a function once on each edge for each incident stub. There are evidently 2^{v} possible compositions of vertex flips. The simultaneous flip of all vertices of G acts trivially on this set of functions and corresponds to reversing the cyclic orderings at all vertices, so only 2^{v-1} such compositions may act non-trivially. Insofar as 2^{e}/2^{v-1}=2^{1-v+e} and there are 1−v+e edges of G−T, the claim follows.

Finally, suppose that G and G′ are equivalent and let φ: F(G)→F(G′) be a homeomorphism restricting to a homeomorphism of G to G′. Performing a vertex flip on G and identifying edges before and after in the natural way produces a fatgraph in which T is still a maximal tree and which is again equivalent to G′, according to previous remarks, by a homeomorphism still denoted φ, which maps T to the maximal tree φ(T)⊂G′. By the previous paragraph, a composition of vertex flips to G to produce a fatgraph G″ may be applied so that an edge of the maximal tree T⊂G″ is twisted if and only if its image under φ is twisted. Adding an edge of G″−T to T produces a unique cycle in G″, and a neighbourhood of this cycle in F(G″) is either an annulus or a Möbius band with a similar remark for edges of G′−φ(T). Since φ restricts to a homeomorphism of the corresponding annuli or Möbius bands in F(G″) and F(G′), an edge of G″−T is twisted if and only if its image under φ is twisted. It follows that G″ and G′ are strongly equivalent as desired.

To summarize: The equivalence class of a fatgraph G is unequivocally determined by a triple σ, Tᵤ, Tₜ of permutations on the same set, where Tᵤ and Tₜ are disjoint involutions. Two such triples σ, Tᵤ, Tₜ and σ′, T′ᵤ, T′ₜ determine strongly equivalent fatgraphs if and only if there is a permutation simultaneously conjugating σ to σ′, Tᵤ to T′ᵤ, and Tₜ to T′ₜ, and they determine equivalent fatgraphs G and G′ if and only if there is a finite sequence of vertex flips on G which produces a fatgraph strongly equivalent to G′. The Euler characteristic X of the surface F(G) can be directly determined as the number of disjoint cycles comprising σ minus the number of disjoint transpositions comprising Tᵤ∘Tₜ.

Let σ′, ρ′ be the permutations determined from σ, Tᵤ, Tₜ with corresponding untwisted fatgraph G′. The boundary cycles and in particular their number r can be computed from the boundary cycles of F(G′) by using a Algorithm 2, and the determination of whether F(G) is connected can then be made by using Algorithm 3. The orientable surface F(G′) is the orientation double cover of F(G), and provided F(G) is connected, F(G) is non-orientable if and only if F(G′) is connected, which can be determined by using Algorithm 1. Provided F(G) is connected, its modified genus is given by g*=(2−X−r)/2.

Background on Protein Structure

Proteins are polymers of amino acids and the imino acid Proline, and each amino acid has the same basic structure, differing only in the side-chain, called the R-group. The carbon atom to which the amino or carboxyl group and side-chain are attached is called the alpha carbon atom C^{α}. Proteins are built from 19 different amino acids and the single imino acid Proline, each of which has known chemical structure and biophysical attributes including charge, three-dimensional structure, and hydrophobicity, which is a measure of the affinity of the side-chain to an aqueous environment.

A protein is a linear polymer of these amino and imino acids which are linked by peptide bonds, and the sequence of covalently bonded amino and imino acids is the primary structure of the protein given as a long word R₁, R₂, . . . , R_{L} in a 20-letter alphabet. The collective knowledge of primary structures of proteins is deposited in the databanks Swiss-Prot and Uni-Prot, which are in the public domain.

The peptide linkages, together with the alpha carbon atoms to which side-chains are attached, form the protein backbone, which is described by

N₁−C₁^{α}−C₁−N₂−C₂^{α}−C₂− . . . −Nᵢ−Cᵢ^{α}−Cᵢ− . . . −N_{L}−C_{L}^{α}−C_{L}

where N denotes nitrogen and C or C^{α} denotes carbon. The backbone thus comes with this preferred orientation from its N to C ends.

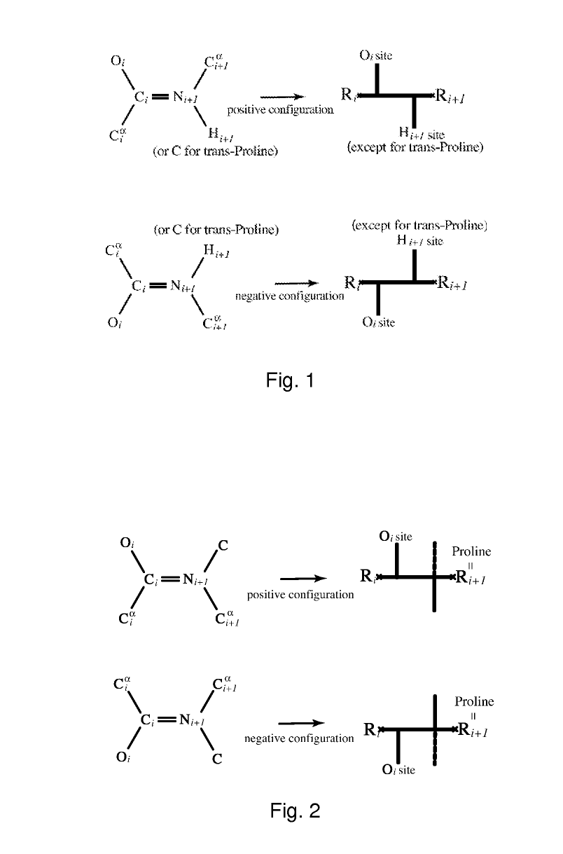

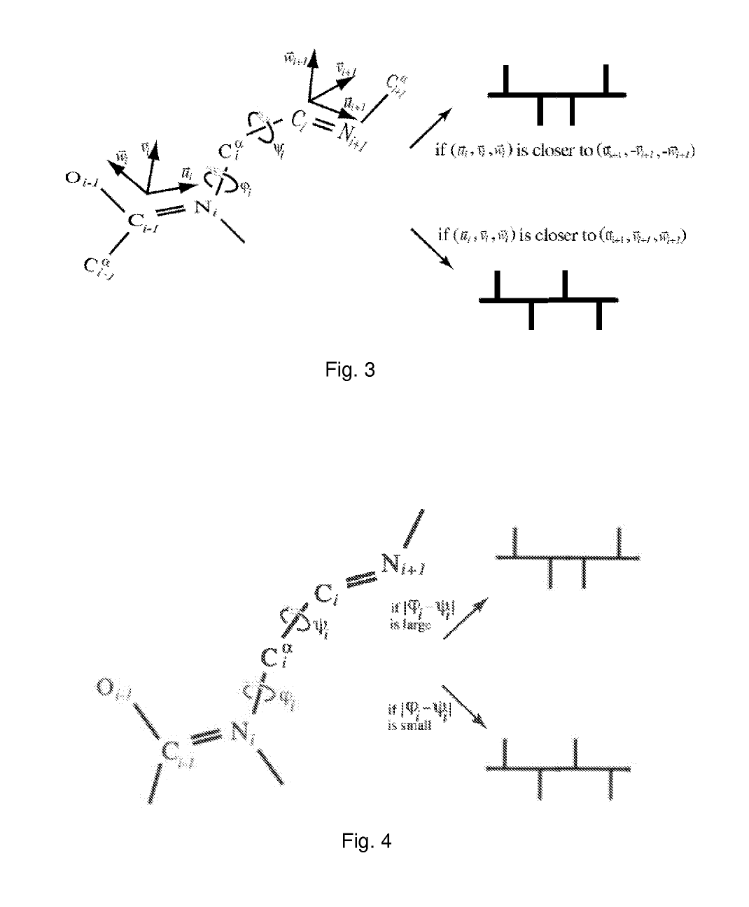

The i'th peptide unit is comprised of the consecutively bonded atoms Cᵢ^{α}−Cᵢ−Nᵢ₊₁−C^{α}ᵢ₊₁ in the backbone together with an oxygen atom Oᵢ bonded to Cᵢ and one further atom. Namely, for any amino acid residue Rᵢ₊₁, the preceding peptide unit includes a hydrogen atom Hᵢ₊₁ bonded to Nᵢ₊₁, while for the imino acid Proline Rᵢ₊₁, the preceding peptide unit includes another carbon atom in the Proline residue bonded to Nᵢ₊₁ as illustrated, respectively, on the left in FIGS. 1 and 2. Owing to quantum mechanical effects, the peptide unit is in any case essentially planar with angles of 120 degrees between adjacent bonds. This is a crucial point about the geometry of proteins. At the same time and by a similar mechanism, each Cᵢ^{α} is always covalently bonded to exactly four other atoms including Cᵢ and Nᵢ, and the angles between the bonds of Cᵢ^{α} with these other atoms are essentially tetrahedral (roughly 109.5 degrees). This is another crucial point about the geometry of proteins.

The configuration of atoms and bonds in the plane of the peptide unit can thus arise in one of two basic conformations depending upon whether the bonds Cᵢ−Cᵢ^{α} and Nᵢ₊₁−Cᵢ^{α} occur on opposite sides (the trans conformation illustrated in FIG. 1) or on the same side (the cis conformation illustrated in FIG. 2) of the bond Cᵢ=Nᵢ₊₁. In fact, peptide units preceding amino acids always arise in the trans conformation, while peptide units preceding the imino acid Proline usually arise in the trans conformation as well but occasionally (roughly ten percent of the time) arise in the cis conformation. The explanation for these phenomena can be found in any standard textbook on proteins.

In a living cell, or more generally in an aqueous solution at room temperature, most water-soluble proteins “fold” into a stable and characteristic three-dimensional crystal, and the tertiary structure is the specification of the spatial coordinates of each constituent atom. This tertiary structure of a protein is determined by nuclear magnetic resonance or X-ray crystallography techniques, and the collective knowledge of tertiary structures is deposited in the Protein Data Bank (PDB), which is in the public domain. However, these locations of backbone atoms in the PDB should be taken with an indeterminacy of roughly 0.2 angstroms owing to experimental and modelling errors. With an even greater indeterminacy, the constituent hydrogen atoms are invisible to X-ray crystallography, and their spatial locations are inferred from an idealized geometry. Furthermore, typical covalent bond lengths along the backbone are on the order of 1.5 angstroms. The primary structure is known for many more protein molecules than is the tertiary structure.

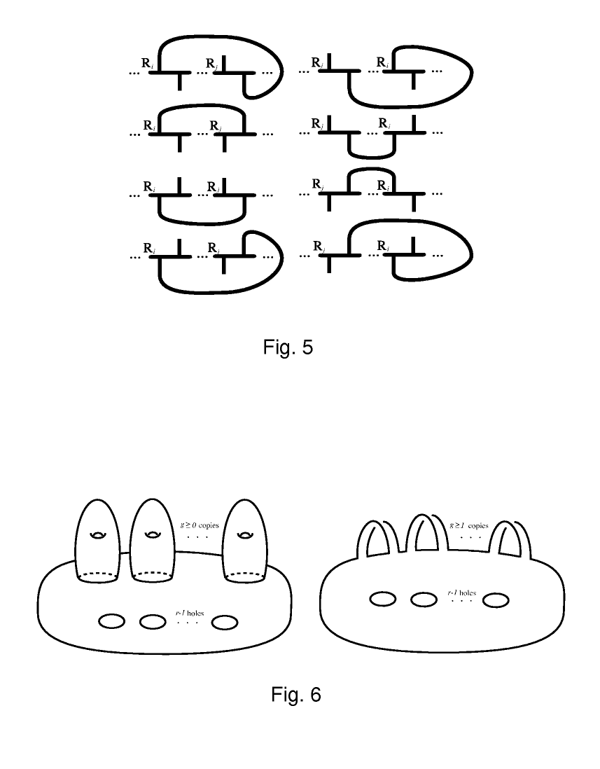

The peptide units of a folded protein are linked along the backbone as determined by the conformational angles φᵢ, ψᵢ defined to be the counter clockwise angle from the bond Cᵢ₋₁−Nᵢ to the bond Cᵢ^{α}−Cᵢ along the bond Nᵢ−Cᵢ^{α}, and ψᵢ, defined to the be counter-clockwise angle from the bond Nᵢ−Cᵢ^{α} to the bond Cᵢ−Nᵢ₊₁ along the bond Cᵢ^{α}−Cᵢ. See FIG. 3. The conformational angles φᵢ, ψᵢ thus determine the linkages between consecutive peptide units and can be unequivocally determined from the actual tertiary structure of a protein in principle, but experimental and modelling errors in the PDB render their determination with an indeterminacy of roughly 10-15 degrees.

The folded protein also determines further bonding between the constituent atoms, for example, hydrogen bonds among the various Oᵢ and Hⱼ, where i, j belong to {1, . . . , L} with |i−j|>1 in practice owing to properties of the backbone, and where two atoms are interpreted as bonded if they are within a few angstroms of one other as determined by the tertiary structure. Specifically, the electrostatic potential energies among constituent atoms of a folded protein are also determined from their spatial separations using any one of several standard methods, and a customary energy cutoff of −2.1 kJ/mole, for example, then determines bonding, i.e., any computed electrostatic bonding energy below the cutoff implies the existence of a hydrogen bond. The specification of hydrogen bonding among the atoms in the peptide units of a protein structure is called its secondary structure. Oxygen atoms may participate in more than one hydrogen bond, with two such bonds being not uncommon in practice, but hydrogen atoms almost always participate in at most one hydrogen bond.

There are several standard configurations of secondary structure in a folded protein which are defined in any textbook on proteins. The first is an α-helix, where typical consecutive conformational angles φᵢ, ψᵢ within an α-helix have small absolute differences with |φ₁−ψᵢ| less than 45 degrees. There are furthermore parallel and anti-parallel beta strands, where typical consecutive conformational angles φᵢ, ψᵢ within a beta strand, whether parallel or anti-parallel, have large absolute differences with |φ₁−ψᵢ| greater than 135 degrees.

There are also a number of standard configurations or motifs of α-helices and β-strands which are catalogued in the literature and are referred to as the architecture of the protein. It is important to emphasize that the determination of architecture is done “by hand” in the sense that there are no automatic methods to recognize motifs even from the full tertiary structure of a protein molecule or protein globule. The topology of the protein structure records the appearance of architecture along the backbone, and finally the homology of a protein describes its approximate primary structure.

A protein decomposes into domains or globules, which are roughly described as the smallest possible subsequences of the backbone mostly saturated for bonding. Another database in the public domain is called CATH, which catalogues the known tertiary structures of what are agreed to be protein globules, and which posits their bonding, conformational angles, architecture, topology and homology. The CATH classification is refined by CATH SOLID, where the SOLI tiers in the hierarchy reflect increasingly better agreement of primary structure as determined by sequence alignment, and the D tier is included to guarantee a unique representative in each deepest class.

At a characteristic temperature somewhat higher than room temperature, the protein molecule or globule “denatures” or melts shedding its hydrogen and other bonds but preserving the backbone. As the temperature is then decreased back to room temperature, a denatured water-soluble protein structure in an aqueous solution regains its bonds and folds back into its native state. At least this is the case for most water-soluble protein globules and molecules. This is a fundamental point: since the protein spontaneously refolds into its native state, the primary structure determines the tertiary structure, and the prediction of the latter from the former is the famous “folding problem” for proteins. A basic tenet of state-of-the-art solutions to the folding problem is that similar primary structure implies similar tertiary structure, so CATH and PDB can be used with postulated penalty functions for partial matching in order to predict new tertiary structures from known ones. The sequence of bonds and spatial coordinates of constituent atoms as the temperature decreases and the protein refolds is called the “folding pathway” of the protein structure.

The folding problem is arguably the fundamental problem of protein biophysics, namely: predict the tertiary structure of a protein molecule or protein globule from its primary structure, and an effective solution to this problem has obvious ramifications for example in de novo drug design. Databases such as PDB and CATH play crucial roles in the state-of-the-art attempts to solve this problem via the following mechanism.

Given a subject protein whose tertiary structure is unknown and whose primary structure is known, one may search for subsequences of its primary structure which agree or roughly agree with subsequences of primary structure occurring for protein structures in PDB or CATH. These approximately agreeing subsequences may overlap, and a penalty function can be postulated a priori in order to determine the best-fitting collection of subsequences of approximate agreement. The presumption is that similar subsequence primary implies similar subsequence tertiary structure, so a mechanism for predicting tertiary structure is derived from the known tertiary structures via such a postulated penalty function based upon a specified database. One aspect of this method which is especially problematic is the assembly of the determined motifs of secondary structure into a full tertiary structure.

### DETAILED DESCRIPTION OF DRAWINGS

FIG. 1 illustrates the modelling of a peptide unit in the trans configuration with the two possible orientations (positive and negative) of the peptide planes. The middle horizontal line segment represents the carbon—nitrogen bond. A vertical line segment is attached on each side of the horizontal line segment, the first and leftmost vertical line segment (half-edge) represents an oxygen site, the second and rightmost vertical line segment represents a hydrogen site. As seen from the figure, the relative position of the first and leftmost vertical line segment (i.e., the oxygen site) corresponds to the location of the oxygen atom on the backbone of the peptide unit when traversed in its natural orientation from the nitrogen end to the carbon end. The second and rightmost vertical line segment (i.e., the hydrogen site) is located on the opposite side of the horizontal line segment.

FIG. 1 also associates two subgraph building blocks when modelling a protein by means of a graph. The endpoints of the horizontal segment are labelled by the corresponding residues denoted by Rᵢ, Rᵢ₊₁ in FIG. 1. The endpoints of the vertical segments not lying in the horizontal segment correspond to the oxygen and hydrogen atoms of the peptide unit and are referred to as the Oᵢ and Hᵢ₊₁ sites as illustrated. Depending upon the orientation of the plane of the peptide unit, exactly one of two possibilities holds: the oxygen atom lies either to the right or the left of the backbone when traversed in its natural orientation from its nitrogen to carbon ends. These two possibilities correspond to the two possible subgraph building blocks for each peptide unit. If the residue Rᵢ₊₁ is the imino acid Proline, then the endpoint of the rightmost vertical segment represents a carbon atom in the Proline residue, which is therefore not involved in hydrogen bonding. This is indicated in FIG. 1 for trans-Proline.

FIG. 2 illustrates the modelling of a peptide unit preceding a cis-Proline with the two possible orientations (positive and negative) of the peptide planes. Just as for the trans conformation illustrated in FIG. 1, exactly one of two possibilities holds: the oxygen atom lies either to the right or the left of the backbone when traversed in its natural orientation from its nitrogen to carbon ends. The second and rightmost vertical line segment represents a carbon site. The dotted line in the figure more accurately reflects the location of the corresponding bond between Nᵢ₊₁ and the carbon atom in the Proline residue, which is again necessarily never involved in hydrogen bonding.

FIG. 2 also associates two subgraph building blocks when modelling a protein by means of a graph, in this case the two possible subgraph building blocks represent peptide units preceding a cis-Proline.

FIG. 3 illustrates how subgraph building blocks can be connected along the backbone when modelling a protein or protein globule by means of a fatgraph. The model of the protein backbone is determined by the sequence of configurations, positive or negative, assigned to the consecutive peptide units and is thus described by a word of length L−1 in the alphabet {±}={+,−}. The untwisted fatgraph modelling the protein backbone is constructed from this data by identifying endpoints of the consecutive horizontal segments of the fatgraph building blocks in the natural way without introducing vertices between them so as to produce a long horizontal segment comprised of 2 L−1 horizontal segments with 2 L−2 short vertical segments attached to it. There is an arbitrary choice of configuration c₁=+ for the first building block as positive.

The Lie group SO(3) is the group of three-by-three matrices A whose entries are real numbers satisfying AA^{t}=I, where A^{t} denotes the transpose of A, i.e., the rows of A^{t} are the columns of A, and I denotes the identity matrix. A distance function or metric on SO(3) is a function d: SO(3)×SO(3)→R satisfying the usual properties of distance, and is said to be bi-invariant provided d(CAD,CBD)=d(A,B) for any A,B,C,D ∈ SO(3). The Lie group SO(3) supports a unique bi-invariant metric

d(A,B)=−½ trace(log(AB^{t}))²

where the trace of a matrix is the sum of its diagonal entries and the logarithm is the matrix logarithm.

For any A₁, A₂ ∈ SO(3), d(A₁,I)<cl(A₂,I) if and only if trace(A₂)<trace(A₁), where d is the unique bi-invariant metric on SO(3).

Suppose that Γ is a graph. An SO(3) graph connection on Γ is the assignment of an element Aₑ to each oriented edge e of Γ so that the matrix associated to the reverse of e is the transpose of Aₑ. Two such assignments Aₑ and Bₑ are regarded as equivalent if there is an assignment Cᵤ ∈ SO(3) to each vertex u of Γ so that Aₑ=CᵤBₑC_{w}⁻¹, for each oriented edge e of Γ with initial point u and terminal point w. An SO(3) graph connection on Γ determines an isomorphism class of flat principal SO(3) bundles over Γ. Given an oriented edge-path γ in Γ described by consecutive oriented edges e₀−e₁− . . . −eₖ₊₁, where the terminal point of eᵢ is the initial point of eᵢ₊₁, for i=0, . . . , k, the parallel transport operator of the SO(3) graph connection along y is given by the matrix product ρ(γ)=Aₑ_{_{—}}₀Aₑ_{_{—}}₁ . . . Aₑ_{_{—k}} ∈ SO(3). In particular, if the terminal point of eₖ₊₁ agrees with the initial point of e₀ so that γ is a closed oriented edge-path, then trace(ρ(γ)) is called the holonomy of the graph connection along γ.

A 3-frame is an ordered triple ℑ=(\vec{u}₁, \vec{u}₂, \vec{u}₃) of three mutually perpendicular unit vectors in R³ so that \vec{u}₃=\vec{u}₁×\vec{u}₂ . For example, the standard unit basis vectors (\vec{i},\vec{j},\vec{k}) provide a standard 3-frame.

An ordered pair ℑ=(\vec{u}₁,\vec{u}₂,\vec{u}₃) and G=(\vec{v}₁,\vec{v}₂,\vec{v}₃) of 3-frames uniquely determines an element D ∈ SO(3), where D\vec{u}ᵢ=\vec{v}ᵢ, for i=1, 2, 3. Furhtermore, the trace of D is given by \vec{u}₁·\vec{v}₁+\vec{u}₂·\vec{v}₂+\vec{u}₃·\vec{v}ₑ, where · is the usual dot product of vectors in R³

Associate a 3-frame ℑᵢ=(\vec{u}ᵢ, \vec{v}ᵢ, \vec{w}ᵢ) to each peptide unit by setting

$${{u}^{->}}_{i} = \frac{1}{\vert {{x}^{->}}_{i} \vert} {{x}^{->}}_{i} , \\ {{v}^{->}}_{i} = \frac{1}{\vert {{y}^{->}}_{i} - ( {{u}^{->}}_{i} \cdot {{y}^{->}}_{i} ) {{u}^{->}}_{i} \vert} ( {{y}^{->}}_{i} ( {{u}^{->}}_{i} \cdot {{y}^{->}}_{i} ) {{u}^{->}}_{i} ) , \\ {{w}^{->}}_{i} = {{u}^{->}}_{i} \times {{v}^{->}}_{i}$$

where |\vec{t}| denotes the norm of the vector \vec{t}.

Thus, \vec{u}ᵢ is the unit displacement vector from Cᵢ to Nᵢ₊₁, \vec{v}ᵢ is the projection of \vec{y}ᵢ onto the specified perpendicular of \vec{u}ᵢ in the plane of the peptide unit, and \vec{w}ᵢ is the specified normal vector to this plane.

Suppose recursively that configurations cₗ ∈ {±} have been determined for I<i<L.

The configuration cᵢ is calculated from the configuration cᵢ₋₁ as follows:

$${c}_{i} = \{ \begin{matrix}+ {c}_{i - 1} , & if {{v}^{->}}_{i - 1} \cdot {{v}^{->}}_{i} + {{w}^{->}}_{i - 1} \cdot {{w}^{->}}_{i} > 0 \\ - {c}_{i - 1} , & if {{v}^{->}}_{i - 1} \cdot {{v}^{->}}_{i} + {{w}^{->}}_{i - 1} \cdot {{w}^{->}}_{i} < 0\end{matrix}$$

This is partly illustrated in FIG. 3, where only the positive configuration in peptide unit i−1 is depicted.

In addition to the 3-frame ℑᵢ=(\vec{u}ᵢ, \vec{v}ᵢ, \vec{w}ᵢ), consider also the 3-frame [symbol] ᵢ=(\vec{u}ᵢ,−\vec{v}ᵢ,−\vec{w}ᵢ), which corresponds to simply turning ℑᵢ upside down by rotating through 180 degrees in three-space about the line containing Cᵢ and Nᵢ₊₁.

As previously indicated, there is a unique element A ∈ SO(3) taking the 3-frame ℑᵢ₋₁ to ℑᵢ and likewise a unique element B ∈ SO(3) taking it to [symbol] ᵢ. Furthermore, d(A,I)≦d(B,I) if and only if trace(B)≦trace(A), where d is the distance function of the unique bi-invariant metric on SO(3), and

trace(A)=\vec{u}_{i 1}·\vec{u}ᵢ+\vec{v}_{i 1}·\vec{v}ᵢ+\vec{w}_{i 1}·\vec{w}ᵢ,

trace(B)=\vec{u}ᵢ₋₁·\vec{u}ᵢ−\vec{v}ᵢ₋₁·\vec{v}₁−\vec{w}ᵢ₋₁·\vec{w}ᵢ,

so that trace(A)-trace(B)=2(\vec{v}ᵢ₋₁·\vec{v}ᵢ+\vec{w}ᵢ₋₁·\vec{w}ᵢ). It is worth emphasizing that also A takes to [symbol] ᵢ₋₁ to [symbol] ᵢ and B takes [symbol] ᵢ₋₁ to ℑᵢ which is reflected in the fact that the condition is symmetric in i−1 and i.

A fundamental aspect of the model is selecting cᵢ=+cᵢ₋₁ if d(A,I)<d(B,I) and cᵢ=−cᵢ₋₁ if d(B,I)<d(A,I). Let Γ denote the graph underlying the fatgraph of the backbone model, and let Aᵢ₋₁,Bᵢ₋₁ ∈ SO(3) denote the respective matrices taking the 3-frame ℑᵢ₋₁ to the 3-frames ℑᵢ, [symbol] ᵢ, for i=2, . . . , L−1. Orient the horizontal segments of Γ from left to right and order them 1, 2, . . . , 2 L−1 from left to right.

Assign to the (2i−1)st oriented horizontal segment the matrix Aᵢ₋₁ ∈ SO(3), for i=2, . . . L−1, and assign to all the other horizontal segments and to all the vertical segments the matrix I ∈ SO(3) to determine an SO(3) graph connection K on Γ.

K is called the backbone graph connection, and it completely describes the evolution of 3-frames of peptide units along the protein backbone. In order to determine the fatgraph model of the backbone, however, one or the other of the two configurations of fatgraph building block for each peptide unit must be chosen, and this choice is made employing the bi-invariant metric d on SO(3) taking cᵢ=cᵢ₋₁ if and only if d(Aᵢ,I)<d(Bᵢ,I).

Thus, the fatgraph model of the protein backbone arises as the natural discretization of the natural SO(3) graph connection K on Γ.

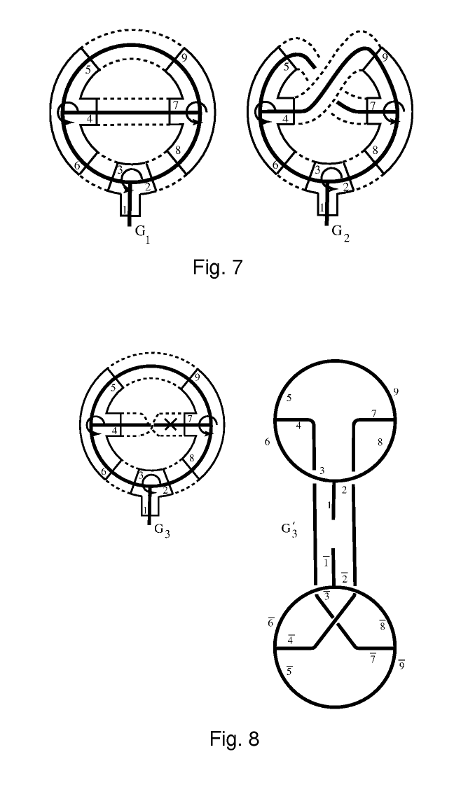

FIG. 4 illustrates the two standard conformational angles φₗ and ψᵢ along the peptide bonds of the backbone incident on the alpha carbon atom Cᵢ^{α}, of the i'th amino acid residue. Two peptide units, as depicted in FIGS. 1 and 2, are incident on this alpha carbon atom, and to each one is associated a subgraph building block. These building blocks are taken to agree if the absolute difference |φₗ−ψᵢ| is “small”, and they are taken to disagree if this absolute difference is “large”, where these notions of “small” and “large” are discussed below. In one embodiment of the invention the building block associated to the (i+1)st peptide unit is determined from the building block associated to the i'th building block, the conformational angles φᵢ, ψᵢ, and the conformation cis or trans of peptide units i and i+1. Only one of the two possible configurations for the i'th building block in its trans conformation is depicted in FIG. 4.

FIG. 5 illustrates modelling of hydrogen bonds, i.e., edges are added to the concatenation of subgraph building blocks representing a backbone. If the oxygen atom Oᵢ of the i'th peptide unit is hydrogen bonded to the hydrogen atom Hⱼ of the j'th peptide unit, then an edge is added connecting the oxygen site of the i'th building block with the hydrogen site of the j'th building block. Adding one such edge for each hydrogen bond along the backbone completes the determination of the graph associated to a protein molecule or protein globule. The various cases depending upon the subgraph building blocks associated to the i'th and j'th peptide units as well as the two cases depending upon i<j or i>j are all depicted.

The untwisted fatgraph T of the backbone model may be regarded as a long horizontal line segment composed of 2 L−1 short horizontal segments with 2 L−2 short vertical segments attached to it. The short vertical line segments represent the atoms Oᵢ, Hᵢ of the peptide units, where Hᵢ is absent (and corresponds to a carbon atom) if residue Rᵢ is Proline, for i=1, . . . , L.

If (i, j) belongs to the collection B of pairs (i, j), then an edge is added to the long horizontal segment connecting the short vertical segments corresponding to the atoms Hᵢ and Oⱼ. The various cases are depicted in FIG. 5.

Applying this to the backbone model T using the hydrogen bonds specified in B, an untwisted fatgraph is provided. This fatgraph is denoted T′. It is important to emphasize that the relative positions of these added edges corresponding to hydrogen bonds other than their endpoints, is completely immaterial to the strong equivalence class of the fatgraph constructed, so this truly produces a well-defined strong equivalence class of untwisted fatgraph uniquely determined from the input data.

To complete the construction, it remains only to determine which edges of the fatgraph T′ are twisted. To this end, suppose that (i, j) ∈ B reflecting that there is a hydrogen bond connecting Hᵢ and Oⱼ. According to the enumeration of peptide units, Hᵢ occurs in peptide unit i−1 and Oⱼ occurs in peptide unitⱼ. As previously written, there are corresponding 3-frames

(\vec{u}ᵢ₋₁, \vec{v}ᵢ₋₁, \vec{w}ᵢ₋₁)=ℑᵢ₋₁

(\vec{u}ⱼ, \vec{v}ⱼ, \vec{w}ⱼ)=ℑⱼ

and corresponding configurations cᵢ₋₁ and cⱼ.

An edge corresponding to the hydrogen bond (i, j) ∈ B is taken to be twisted if and only if cᵢ₋cⱼ sign (\vec{v}ᵢ₋₁ \vec{v}ⱼ+\vec{w}ᵢ₋₁·\vec{w}ⱼ) is negative.

Applying this to the untwisted fatgraph T′ completes the definition of the fatgraph denoted G₁=G₁(Eₘᵢₙ, Eₘₐₓ), the fatgraph model of the protein structure determined by the inputs based on the bifurcation parameter β=1 and energy thresholds Eₘᵢₙ<Eₘₐₓ<0. In this notation, β is a parameter of the model that determines the maximum number of hydrogen bonds in which an oxygen or hydrogen atom may participate, and the energy thresholds are likewise parameters of the model which determine a hydrogen bond with energy E provided Eₘᵢₙ<E<Eₘₐₓ with the standard default values Eₘₐₓ=−0.5 kcal/mole and Eₘᵢₙ given by minus infinity.

There are several points to make about this determination. Though it is not clear from this formulation, hydrogen bonds are thereby treated in the same manner as the linkages between peptide units, and this is natural from the point of view of SO(3) graph connections. Furthermore, under errors of determinations of which edges are twisted and errors in the plus/minus sequence, the number of boundary components of F(G) will change by at most the total number of errors. This is a crucial point.

The fatgraph G can be further labelled using the primary structure in the natural way, where the label Rᵢ of the i'th residue is associated to the sub-segment of the long horizontal segment along the backbone immediately preceding the short vertical segment representing Oᵢ, for i=1, . . . , L.

FIG. 7 illustrates the construction of a surface F(G) with boundary from a fatgraph G for two untwisted fatgraphs G₁ and G₂ depicted as heavy lines, where the cyclic ordering is the counter-clockwise ordering of the plane depicted containing the vertices. The boundary of a neighbourhood in this plane of a k-valent vertex of G=G₁ or G=G₂ decomposes into 2k arcs, and the alternating arcs crossing the edges of G are called stubs. The various stubs are enumerated 1 through 9 for each of the two fatgraphs G₁ and G₂ indicated in FIG. 7. Each such neighbourhood comes equipped with the orientation of the plane, and bands, which are represented in FIG. 7 as dotted lines, are added to these neighbourhoods attached to the stubs and respecting the orientations. The union of these neighbourhoods, one for each vertex of G, and these bands, one for each edge of G, determines the surface F(G) with boundary associated to G.

FIG. 8 illustrates the construction of a surface from a fatgraph in analogy to that depicted in FIG. 7 but now for a fatgraph G₃ with a twisted edge on the left of the figure. The corresponding edge is marked with an icon “x”, the corresponding band is twisted, and the corresponding surface F(G₃) is non-orientable. On the right of the figure, an untwisted fatgraph G₃′ derived from the twisted fatgraph G₃ is depicted, whose corresponding surface F(G₃′) is called the “orientation double cover” of F(G₃) in mathematics.

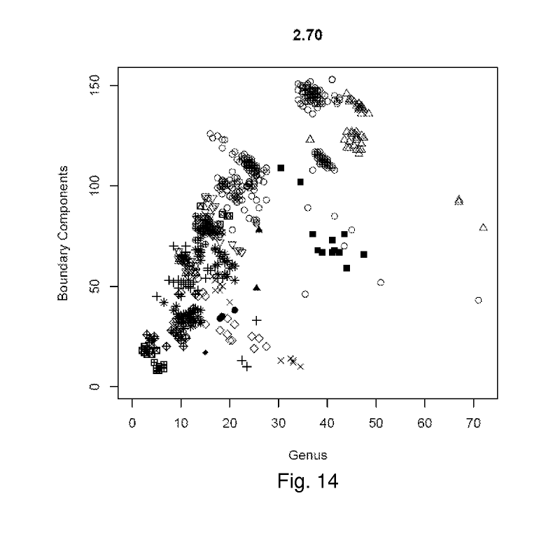

FIG. 9 gives the standard Ramachandran plot of occurring pairs of conformational angles for the full CATH database. Overlaid on this plot, there are level sets indicated for a certain function arising in one embodiment of the present invention, namely, the function \vec{v}ᵢ₋₁·\vec{v}ᵢ+\vec{w}ᵢ₋₁·\vec{w}ᵢ in the notation developed in the description of FIG. 3. Since the zero level set largely avoids the densely populated regions of the Ramachandran plot, the occurrences of indeterminacy in the construction of the backbone where this function is nearly zero are relatively rare.

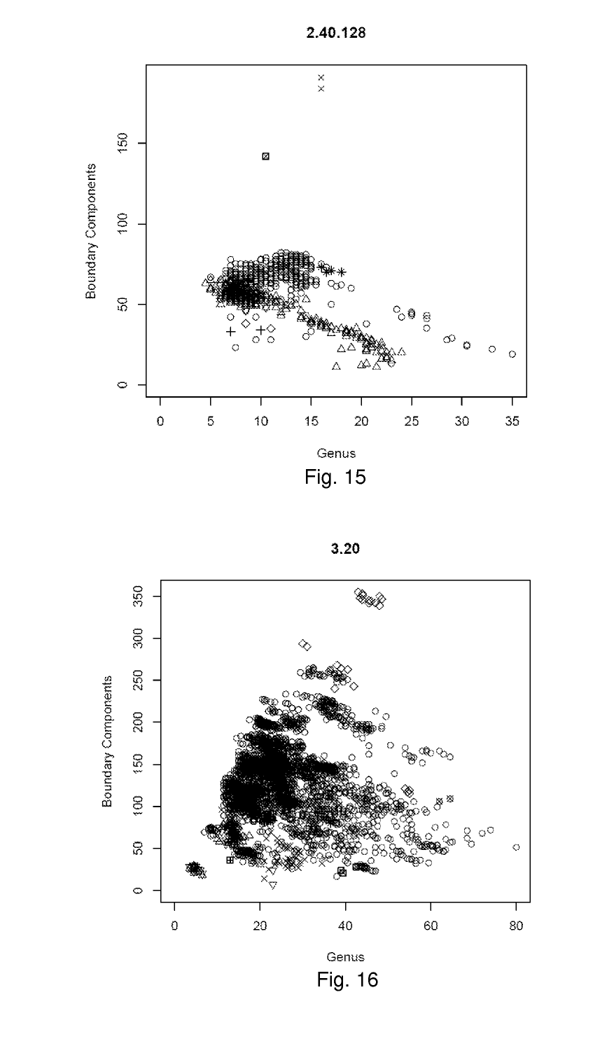

FIG. 10 shows how alpha helices and beta strands are manifest in the fatgraph model. Only the case with bifuraction parameter β=1 is considered for simplicity. The illustration on the top of FIG. 10 depicts the fatgraph model of an alpha helix, which is described by a constant plus/minus sequence + + + + + or − − − − −. There are several ways to see this. For example, from the Ramachandran plot FIG. 9 or from the direct consideration of 3-frames associated to an alpha helix. The hydrogen bonding of an alpha helix is as indicated in FIG. 10. Indeed, this is the standard graphical depiction of an alpha helix in the protein literature, but in the case of fatgraph modelling, there is the deeper meaning of the figure as a fatgraph rather than simply as a graph in its usual interpretation. The dotted line indicates a typical boundary component of the corresponding surface.

The second illustration from the top in FIG. 10 depicts the fatgraph model of a typical anti-parallel beta strand, which is described by an alternating plus/minus sequence + − + − + or − + − + − as for example as substantiated from FIG. 9 or from direct considerations of 3-frames. The horizontal arrows indicate the natural orientation of the backbone from its nitrogen to carbon termini. Again, this is the standard graphical depiction of an anti-parallel beta strand but now with this enhanced fatgraph interpretation. The dotted lines indicate typical boundary components of the corresponding surface. Suppose for definiteness that the backbone from its nitrogen to carbon termini extends from the top horizontal line to the bottom horizontal line. Consider the effect of a change of single configuration type, from + to − or − to +, on the coil between these two backbone snippets as depicted in the third illustration from the top in FIG. 10. It follows that the vertical edges corresponding to hydrogen bonds will now be twisted. Indeed, an odd number of changes of configuration types in the coil will produce the analogous result, and an even number leaves the figure unchanged.

The bottom two illustrations in FIG. 10 likewise depict a parallel beta strand, again demonstrating the characteristic alternating plus/minus sequence of a beta strand and the stability of typical boundary components indicated by dotted lines. Again, the first such illustration gives the usual depiction of a parallel beta strand in its refined interpretation here as a fatgraph rather than just as a graph.

In short, the passage from graph to fatgraph enhances the usual depiction of alpha helices and beta strands. Changes of configuration types in coils leaves undisturbed the basic fatgraph structures in FIG. 10, which model alpha helices and beta strands. New distinctions among alpha helices and beta strands arise naturally based on this enhanced fatgraph structure. Furthermore, new classifications of coils and turns arise as well, for example, the sequence of configurations, plus or minus, of the peptide units in a coil or turn.

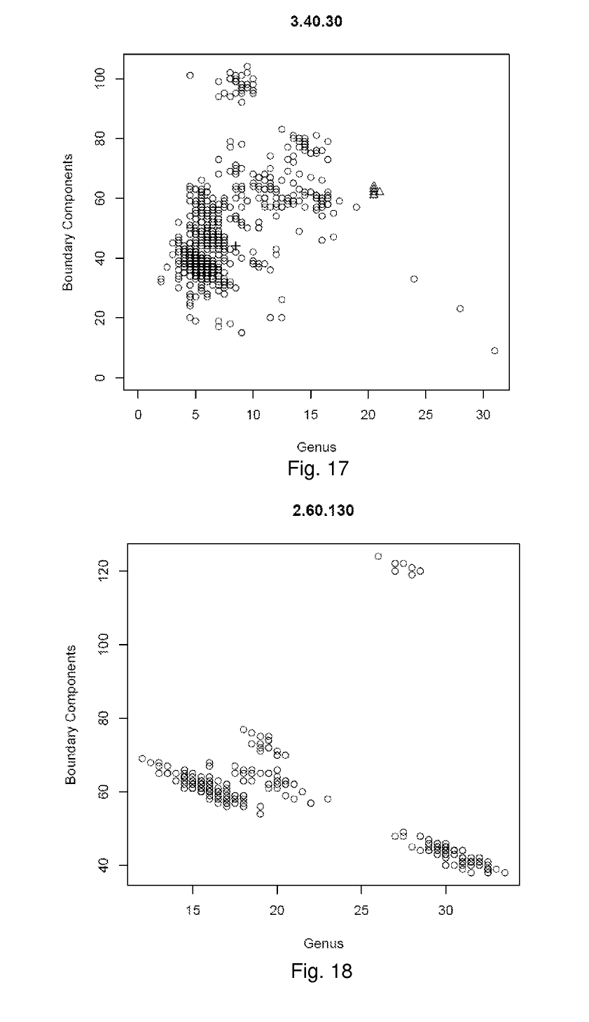

FIG. 11 provides a flow chart for one embodiment of the invention when modelling a protein or a protein globule by means of a fatgraph. The preferred embodiment is implemented in Java, and there are two data classes, Cycle and Permutation. The main routine is described by the flow chart in FIG. 11.

Program segment 1 reads the raw data of a protein molecule or protein globule structure from the PDB and determines the highest occupancies for each carbon and nitrogen atom along the backbone. If there is not complete and contiguous data along the backbone, then the file for this globule is regarded as incomplete, and the program terminates. (In other embodiments discussed later, this restriction of contiguity of the sequence of atoms along the backbone is removed.) If the data is complete, the 3-frames for each peptide unit are calculated in Program segment 4. After the initialization in Program segment 5, Program segments 6-9 inductively calculate the configurations of building blocks as positive or negative along the backbone, where this determination is made based upon the relative positions of consecutive peptide planes as described previously. At this point in the code, the untwisted fatgraph model for the protein backbone has been constructed as the permutation sigma and part of the permutation tau. Each peptide unit contributes two cycles of length three to sigma and one cycle of length two to tau in the notation of the discussion of the preferred embodiment the enumeration of stubs is given by the counter-clockwise cyclic order.

Program segment 10 reads the data of all hydrogen bonds along the backbone and selects only the strongest one incident on each site. Program segments 11-14 determine which of the selected hydrogen bonds are twisted and untwisted again based on the relative positions of peptide planes as described before. At this point in the program routine, the full possibly twisted fatgraph has been constructed as a pair of permutations sigma and tau, where tau is comprised not only of the transpositions tau p from the peptide bonds but also tau_u for the untwisted bonds and tau_t for the twisted ones.

Program segment 15 implements the construction of the permutations sigma prime and tau prime of the orientation double cover from sigma and tau. The length spectrum of the orientation double cover is directly calculated from the composition rho_prime of sigma_prime and tau_prime, and the determination is made as to whether it is connected based upon an algorithm described in the preferred embodiment of the invention. Program segment 16 finally determines the length spectrum of the original fatgraph from the length spectrum of its orientation double cover: each boundary component of the former occurs twice (in its two orientations) as a boundary component of the latter. It is straightforward to then calculate the modified genus and other basic properties of the original fatgraph associated with the protein.

### Example of a Preferred Embodiment of the Invention

In the following, a method for modelling a protein or protein globule by means of a graph will be described. As input to the method is provided the specification for a folded protein, protein globule, or any consecutive sequences along the backbone which is saturated for hydrogen bonding of:
i) the primary structure given as a sequence Rᵢ of letters in the 20-letter alphabet of amino and imino acid residues, for i=1, . . . , L,
ii) the displacement vector \vec{x}ᵢ from Cᵢ to Nᵢ₊₁ and the displacement vector \vec{y}ᵢ from Cᵢ^{α} to Cᵢ in each peptide unit, for i=1, . . . , L−1,
iii) the determination of hydrogen bonding among {Hᵢ, Oᵢ: i=1, . . . , L} described as a collection B of pairs (hⱼ, oⱼ) indicating that Hₕ_{_{—}}ⱼ is bonded to Oₒ_{_{—}}ⱼ, where hⱼ, oⱼ belong to {1, . . . , L} and j=1, . . . , B.

These data are either immediately given in or readily derived from the Swiss-Prot, PDB, and CATH databanks for example, and the first step a) of this embodiment of the invention is reading this data as determined from the primary and tertiary structures. The method is further described by consecutive steps b), c), d) and e).

Step b) determines the concatenation of fatgraph building blocks which describe the geometry of the backbone. The two possible configurations for the fatgraph building blocks for the backbone are described as positive (+) or negative (−) as illustrated in FIGS. 1 and 2. Step b) of the invention thus determines the sequence of configurations, positive or negative, for each consecutive building block comprising the backbone. There is an arbitrary choice of configuration c₁=+ for the first building block as positive. This choice does not affect the isomorphism type of the fatgraph to be constructed, and hence neither does it affect any of the derived properties to be defined.

Associate a 3-frame ℑᵢ=(\vec{u}ᵢ, \vec{v}ᵢ, \vec{w}ᵢ) to each peptide unit by setting

$${{u}^{->}}_{i} = \frac{1}{\vert {{x}^{->}}_{i} \vert} {{x}^{->}}_{i} , \\ {{v}^{->}}_{i} = \frac{1}{\vert {{y}^{->}}_{i} - ( {{u}^{->}}_{i} \cdot {{y}^{->}}_{i} ) {{u}^{->}}_{i} \vert} ( {{y}^{->}}_{i} ( {{u}^{->}}_{i} \cdot {{y}^{->}}_{i} ) {{u}^{->}}_{i} ) , \\ {{w}^{->}}_{i} = {{u}^{->}}_{i} \times {{v}^{->}}_{i}$$

where |\vec{t}| denotes the norm of the vector \vec{t}, denotes the scalar product and × denotes the cross product. Thus, \vec{u}ᵢ is the unit displacement vector from Cᵢ to Nᵢ₊₁, \vec{v}ᵢ is the projection of \vec{y}ᵢ onto the specified perpendicular of \vec{u}ᵢ in the plane of the peptide unit, and \vec{w}ᵢ is the specified normal vector to this plane.

Suppose inductively that configurations cₗ ∈ {±}={+,−} have been determined for i<I<L. Assuming first a trans conformation in peptide units I−1 and I as specified by inputs i) and ii), the determination of the configuration c_{I} is calculated from the configuration c_{I-1} as follows:

$${c}_{l} = \{ \begin{matrix}+ {c}_{l - 1} , & if {{v}^{->}}_{i - 1} \cdot {v}^{->} + {{w}^{->}}_{i - 1} \cdot {{w}^{->}}_{i} > 0 \\ - {c}_{l - 1} , & if {{v}^{->}}_{i - 1} \cdot {{v}^{->}}_{i} + {{w}^{->}}_{i - 1} \cdot {{w}^{->}}_{i} < 0\end{matrix}$$

This is partly illustrated in FIG. 3, where only the positive configuration in peptide unit i−1 is depicted.

The explanation for this determination comes from advanced geometry. In addition to the 3-frame ℑᵢ=(\vec{u}ᵢ, \vec{v}ᵢ, \vec{w}ᵢ), consider also the 3-frame ℑ′ᵢ=(\vec{u}ᵢ,−\vec{v}ᵢ,−\vec{w}ᵢ), which corresponds to simply turning ℑᵢ upside down by rotating through 180 degrees in three-space about the line containing Cᵢ and Nᵢ₊₁.

There is a unique element g of the Lie group SO(3) taking the 3-frame ℑᵢ₋₁ to 3, and likewise a unique element g′ of SO(3) taking it to ℑ′ᵢ. This determination of fatgraph building block corresponds (after some calculation) to making the choice of building block whose associated 3-frame ℑᵢ or ℑ′ᵢ has corresponding element g or g′ closest to the identity under the unique bi-invariant metric on SO(3). It is in this manner that precise mathematical sense of triples of vectors being nearby can be provided, as it was described before, and it is worth mentioning that this approach applies a standard mathematical tool called an “SO(3) graph connection” which is here discretized using the bi-invariant metric into two possible configurations in order to construct the fatgraph model of the backbone.

Even if one or more of the peptide units i−1 or i precedes a cis-Proline, the same fatgraph building blocks are still associated, but their interpretation and the inductive determination of the configuration c, are slightly modified. Namely, assign a building block as illustrated on the right in FIG. 2 by solid lines to a peptide unit preceding cis-Proline even though the dotted line would more appropriately indicate the approximate location of the bond from Nᵢ₊₁ to the carbon in the Proline residue. Since this carbon atom is of course in any case not involved in any hydrogen bonding, this does not substantively affect the fatgraph to be constructed. Letting c_{I} denote the determination of sign given by the formulas above, the correct configuration c_{I} for the I'th peptide unit is given by

$${c}_{l}^{′} = \{ \begin{matrix}- {c}_{l} , & if the ( l - 1 ) st peptide unit is cis - Proline \\ + {c}_{l} , & else\end{matrix}$$

so it is only upon exiting a cis-Proline that there a change of configuration type from the earlier trans/trans determination.

In any case, there is the tacit assumption that there is never equality in the determination between the two cases. Of course, in practice, the condition \vec{v}ᵢ₋₁·\vec{v}ᵢ+\vec{w}ᵢ₋₁·\vec{w}ᵢ=0 never occurs exactly, but there is the real possibility that such a condition nearly holds. Choose some cutpoint threshold below which one cannot reliably choose between the two cases if the data occur below this threshold, and call a residue a cutpoint if it is between two peptide units whose data occur below the cutpoint threshold. The locus of cutpoints is visualized in FIG. 9 as lying near the zero locus displayed upon a Ramachandaran plot of CATH. The following is under the assumption that there are no cutpoints (taking the cutpoint threshold to be zero).

The construction of the untwisted fatgraph is completed as follows: The output of Step b) can be regarded as a long horizontal line segment representing the backbone and arising from the concatenation of the fatgraph building blocks together with short vertical line segments attached to this horizontal segment representing the atoms Oᵢ, Hᵢ of the peptide units, where Hᵢ is absent (and corresponds to a carbon atom) if residue Rᵢ is Proline, for i=1, . . . , L. The vertical segment representing Oᵢ may lie on the right or left of the long horizontal segment, in which case the vertical segment representing Hᵢ lies on the left or right respectively. In any case, if Hₕ_{_{—}}ⱼ is determined to be hydrogen bonded to Oₒ_{_{—}}ⱼ, i.e., if (hⱼ, oⱼ) ∈ B coming from input iii), an edge is added to the long horizontal segment connecting the short vertical segments corresponding to the sites Hₕ_{_{—}}ⱼ and Oₒ_{_{—}}ⱼ. The various cases are illustrated in FIG. 5. It is important to emphasize that the relative positions of these added edges corresponding to hydrogen bonds other than their endpoints is completely immaterial to the isomorphism type of the fatgraph constructed, so Step c) truly produces a well-defined untwisted fatgraph G uniquely determined from the input data.

To complete Step c), it remains only to determine which edges of the fatgraph G are twisted. To this end, suppose that (hⱼ, oⱼ) ∈ B reflecting that there is a hydrogen bond connecting Hₕ_{_{—}}ⱼ and Oₒ_{_{—}}ⱼ. A 3-frame ℑₕ=(\vec{u}ₕ, \vec{v}ₕ, \vec{w}ₕ) and a backbone configuration cₕ=cₕ_{ⱼ}₋₁ have previously been associated to the (hⱼ−1)st peptide unit containing Hₕ_{_{—}}ⱼ and a 3-frame ℑₒ=(\vec{u}ₒ, \vec{v}ₒ, \vec{w}ₒ) and a backbone configuration cₒ=cₒ_{_{—}}ⱼ to the oⱼ'th peptide unit containing Oₒ_{_{—}}ⱼ.

The edge of G corresponding to the bond (hⱼ, oⱼ) ∈ B is taken to be twisted if and only if

cₒcₕsign(\vec{v}ₕ·\vec{v}ₒ+\vec{w}ₕ·\vec{w}ₒ)=−1

There are several points to make about this determination. First of all, notice that there is again a question of cutpoint threshold for the determination between the two cases.

Though it is not clear from this formulation, one can show that hydrogen bonds are thus treated in the same manner as the linkages between peptide units, and this is natural from the point of view of SO(3) graph connections. The most important point, however, which is related to cutpoint thresholds, is that one can show that under errors of determinations of which edges are twisted and errors in the determinations of linkages along the backbone between peptide units, the number of boundary components of F(G) will change by at most the total number of errors. This crucial point will be amplified subsequently.

The fatgraph output from Step c) can be further labelled using the primary structure in the natural way, where the label Rᵢ of the i'th residue coming from input i) is associated to the sub-segment of the long horizontal segment following the short vertical segments representing Oᵢ, for i=1, . . . , L.

It may in practice be useful in Step c) to allow for multiple hydrogen bonds along the backbone rather than just the single hydrogen bonds described here. For a multiply bonded hydrogen or oxygen site, the corresponding short vertical segment will now terminate at a higher valence vertex, whose cyclic ordering arises from projection of its partners in bonding into the plane of its peptide unit. Though small further modifications are necessary, there is no obstruction to this extension of the method (which is elucidated in a subsequent discussion of another example of embodiment).

Step d) consists of post-processing of the data type of the possibly labelled fatgraph G which is the output of the previous step. Specifically, G is described as a pair of permutations σ, T together with the specification of which transpositions in T are twisted. In this case, σ consists of a collection of 2 L−2 cycles of length three, which are explicitly determined from the sequence cᵢ ∈ {±}, for i=1, . . . , L−1, specified in Step b), T consists of a collection of B+2 L−3 transpositions, which are explicitly either given or determined from the hydrogen bonding in input iii), and the twisting is determined as was already described based upon input i) and the output of Step b). Natural a priori invariants are the number L of residues and B of hydrogen bonds, which are given as inputs i) and iii).

The most basic derived data are the genus g and number r of boundary components of the associated surface F(G), which were discussed before. A small technical point is the difference between orientable and non-orientable surfaces in the formula relating Euler characteristic and genus described before. To overcome this point, the modified genus is introduced:

$${g}^{*} = \{ \begin{matrix}g , & if F ( G ) is orientable ; \\ g / 2 , & if F ( G ) is non \text{-} orientable ,\end{matrix}$$

so the formula v−e=2−2 g*−r therefore pertains in either case of orientable or non-orientable surfaces.

It follows from the expression X=v−e for the Euler characteristic that removing from G any edges with univalent vertices (for example, arising from any short vertical segments not involved in hydrogen bonding), removing their univalent vertices as well, and amalgamating into a single edge the resulting pair of edges incident on the resulting bivalent vertex leaves X invariant, so X=1−B=2−2 g*−r, where B is the number of hydrogen bonds given in input iii). Thus, B and r together determine

$${g}^{*} = \frac{1 + B - r}{2}$$

To finally calculate r, provide the algorithms described before that determine r in terms of G, namely, the number of cycles of ρ=σ∘T for an untwisted fatgraph and the related algorithm on the orientation double cover for a possibly twisted fatgraph. It is straight-forward to implement this algorithmic calculation of r on a computer and hence complete the computation of the most basic topological invariants g* and r of a folded protein molecule or protein globule.

Other natural invariants whose calculation are likewise amenable to computer implementation and depend upon this description of the boundary components of F(G) as the cycles of ρ include:
the length spectrum given by the unordered tuple of lengths of all boundary components of F(G),
the average length of a boundary component of F(G),
the standard deviation of the lengths of the boundary components of F(G), and
other standard summary statistics of the length spectrum.

At the same time now using the primary structure given as input i), the length spectrum for each residue type might furthermore be computed, namely, the unordered tuple of lengths of boundary components of F(G) passing through a given residue type, and likewise averages and other summary statistics of these ensembles might be computed for each of the 20 residue types. For example, the Glycine and Proline length spectra should be useful for classifying anti-parallel beta proteins.

It is worth mentioning that several notions of the length of a boundary component are possible. For example, the length of a closed edge-path could be taken as the number of edges traversed in G, or it could be taken as the number of peptide units visited. Indeed, for each residue type, each boundary component visits a certain number of residues of this type, and further variations of the notion of length arise from assigning weights to the various residue types and taking the weighted sum over residues visited.

It is also worth pointing out that the underlying graph of the fatgraph also has its own invariants, for example, there is an associated notion of length spectrum, namely, one or another of the notions of generalized length discussed above of the closed edge-paths or simple closed edgepaths on the graph. Invariants of this type, which can be derived from the graph underlying the fatgraph, may also be of importance in practice.

The fatgraph associated to a protein globule or molecule is of a special type, in that it has a “spine” arising from the backbone, namely, a canonical embedded line which passes through each non univalent vertex. This “spined fatgraph” admits a canonical “reduction” by simply removing each edge with a univalent vertex as endpoint and amalgamating the resulting pair of edges incident on each bivalent vertex into a single edge as before. Notice in particular that the small vertical edges arising from the carbon atom in the peptide unit preceding cis-Proline are simply removed in the reduced fatgraph. The graph underlying this reduced spined fatgraph is a so-called “chord diagram”, and there are many interesting so-called “quantum invariants associated with weight systems” including but not limited to the Conway, Jones, or HOMFLY knot polynomials. The SO(3) graph connection itself, which was described before, also leads to standard numerical and other invariants. Thus, countless interesting numerical classical and quantum invariants associated with the reduced spined fatgraph and the graph which underlies it, are provided by the system and method according to the invention.

The most precise invariant of this embodiment of the invention is the isomorphism type of the possibly labelled fatgraph itself. This is likely too restrictive an invariant to be of great benefit for classifying or comparing protein molecules or protein globules since the isomorphism type of the unlabelled reduced spined fatgraph constructed by this preferred embodiment of the invention is likely to uniquely determine each globule in CATH for example.

On the other hand, there are natural notions of similarity of fatgraphs which should be of benefit. For example, a mutation of a protein fatgraph structure can be defined to be one of the following modifications:
1) insert or delete a peptide unit whose hydrogen and oxygen sites are unbonded;
2) insert or delete an edge connecting unbonded hydrogen and oxygen sites in different peptide units; or
3) alter the construction of the fatgraph by changing the building block of one peptide unit from + to − or − to +.

It is clear that any two fatgraphs arising from a protein molecule or protein globule are related by a finite sequence of mutations. By assigning a penalty of some magnitude to each type of mutation, the mutation distance between two such fatgraphs can be defined to be the minimum sum of penalties corresponding to sequences of mutations relating them. Two protein molecules or protein globules may be regarded as being similar if the mutation distance between them is small, and this gives another method of classifying or comparing them. Still other notions of distance, mutation, and mutation distance likewise give still further such methods.

It is important to mention that some of the data in CATH and PDB are incomplete with missing atomic locations for example, and the determination of a fatgraph according to certain embodiments is thus problematic for these protein molecules or protein globules. These notions of mutation distance presumably rectify this problem and allow one possible treatment of incomplete or partially corrupted data (and other treatments are described in the subsequent discussion of another embodiment)

Whole families of further invariants arise by deleting from the fatgraph edges corresponding to hydrogen bonds of low energy or which connect peptide units that are far apart or close together along the backbone, finally calculating the invariants discussed before for these altered fatgraphs. For example, the modified genus thereby may be regarded as a function of energy.

Finally, the treatment of cutpoints is discussed. The most primitive treatment is to disregard them entirely by taking the cutpoint threshold to vanish as in the earlier discussion. Another treatment involves resolving cutpoints in all possible ways and simply averaging the numerical or other invariants discussed before over this finite set of fatgraphs, and this is feasible at least for globules since the number of cutpoints in practice tends to be rather small for reasonable thresholds. Notice that by taking the weight of mutations 3) and 4) to be comparably small, the mutation distance between fatgraphs with different resolutions of cutpoints will be small. A sad fact is that the experimental indeterminacies of X-ray crystallography, which were quantified before, make the calculation of realistic experimental cutpoint thresholds problematic.

A crucial point mentioned before is that the preferred embodiment produces a fatgraph many of whose invariants are relatively insensitive to errors in linkages between peptide units and errors in twisting of hydrogen bonds. These “robust” invariants include essentially all of those mentioned so far including r, g*, summary statistics of length spectra and modified length spectra as well as the residue-specific length spectra, and many of the quantum invariants. Two further basic robust invariants are the number of times that there is a change between consecutive configurations cᵢ≠cᵢ₊₁ and the number of hydrogen bonds so that cₒcₕ sign(\vec{v}ₒ·\vec{v}ₕ+\vec{w}ₒ™\vec{w}ₕ)=−1 in the earlier notation. An example of a non-robust invariant is the unmodified genus g since the orientability or non-orientability of F(G) can depend upon a single twist.

As long as attention is restricted to such robust invariants, cutpoints may simply be ignored entirely (taking all cutpoint thresholds to be zero as in the primitive treatment), where the twisted fatgraph and its invariants are regarded as well-defined only in some statistical sense. Of course, it is useful also to demonstrate the robustness of the invariants singled out by numerical experiments that prove their convergence to well-defined values under decreasing cutpoint thresholds in practice. This is very much in the same spirit as using fatgraphs that are nearby in the sense of mutation distance as the arbiter of similarity of protein globules or molecules. As in that discussion, incomplete or partially corrupted data, for example, missing atomic locations along the backbone, can simply be ignored by calculating configurations just as before but now for not necessarily contiguous peptide units again with the caveat that only robust invariants may be considered as significant attributes of the statistical fatgraph.

(This is further explicated in a subsequent discussion of another example of embodiment.)

Step e) of the preferred embodiment is the classification, comparison, specification, analysis, and prediction of protein molecule or protein globule structures in terms of the topological, numerical, and other invariants in Step d) of the possibly labelled twisted fatgraph constructed in Step c).

In fact, taking the length of a curve to be the number of peptide units traversed, all of the standard α-helices and parallel or antiparallel β-strands give rise to consecutive boundary components of length four. (There are uncommon anti-parallel beta exceptions to this though.) The length spectrum and/or the plus/minus sequence of configurations of what remains gives a new classification of protein coils and turns. Moreover, sequences of alternating configuration types seem to be a very good predictor of β-strands.

Furthermore, the length spectrum or other attributes of the fatgraph may provide a tool for recognizing or determining biological function or activity in a protein molecule or protein globule structure. For example, active sites of the structure, i.e., those atomic locations involved in protein-protein, protein-ligand, protein-nucleotide, nucleotide-nucleotide, etc., interactions, may correspond to sites whose adjacent boundary curves are especially long or short according to some possibly generalized notion of length. For another example, protein docking may be predicted by matching boundary curves of comparable possibly generalized length on the two interacting molecular structures.

### Results from CATH Libraries of this Embodiment

In order to illustrate the efficacy and prove the feasibility of the methods of the present invention in a simple example, the calculation of the modified genus g*, number r of boundary components, as in the earlier notation, and the calculation of the length spectrum are provided for the various families of the CATH databank on the levels of C, CA, CAT, and CATH. The CATH Protein Structure Classification is a semi-automatic, hierarchical classification of protein domains. The name CATH is an acronym of the four main levels in the classification:
1. Class: the overall secondary-structure content of the domain
2. Architecture: a large-scale grouping of topologies which share particular structural features
3. Topology: high structural similarity but no evidence of homology.
4. Homologous superfamily: indicative of a demonstrable evolutionary relationship.

CATH defines four classes: mostly-alpha, mostly-beta, alpha and beta, few secondary structures.

These illustrated examples are performed without regard to cutpoints (taking the cutpoint threshold to vanish), simply discarding any corrupt or incomplete data (including non-contiguous data), with length defined as the number of peptide units visited, and using the full database of complete CATH files even though this introduces a bias resulting from “experimentally popular” entries in CATH. Furthermore, only the strongest hydrogen bonds are recorded at each site in this sample implementation, though the extension to bifurcated hydrogen bonds is straight-forward as discussed before (and elucidated later). Any protein globule whose backbone is not a contiguous sequence of residues is discarded although this is not a necessary constraint of the present invention as mentioned before (and this restriction is removed in a later discussion of another embodiment).

An important remark is that the library or libraries of fatgraph structures derived in this way from PDB or CATH, can be used in the same manner as PDB or CATH themselves as the basis for methods of predicting tertiary or secondary structure from primary structure. As in the earlier discussion, approximate agreement of subsequences of the primary structure of a subject protein molecule or protein globule with primary structures occurring in the libraries of fatgraph structures, can be used to determine a fatgraph for the subject protein which best matches those in the libraries based on a postulated penalty function. Thus, fatgraph libraries themselves are the basis of novel methods of predicting the folded protein from its primary structure. Furthermore, the especially problematic step of assembling motifs into a full tertiary structure based on PDB is obviated or at least modified by predicting the fatgraph structure based on a fatgraph library. Another important remark is that the possibly labelled fatgraph and its numerical or other invariants depend upon the input data at a fixed temperature. As the temperature is varied, so too does the input data vary, and hence the fatgraph and its numerical and other invariants can also be seen as functions of temperature. Thus, a discrete dynamical model of protein melting or folding pathways is provided by the evolution of the fatgraph as a function of temperature. More explicitly, the displacement vectors in input ii) and the bonds in input iii) depend upon the temperature, and hence so too do the outputs of Steps b) and c). Numerical and other invariants are defined exactly as in Step d) but now depend upon a possibly labelled fatgraph that is temperature dependent. For example, a method of modelling melting at least near the crystallized state may arise by simply omitting hydrogen bonds of low energy, as discussed before, or removing bonds that connect peptide units that are far apart along the backbone.

As described above, the fatgraph and its modified genus g* (which will be referred to simply as the genus), number r of boundary components, length spectrum and other invariants have been computed for each complete entry of the entire CATH databank.

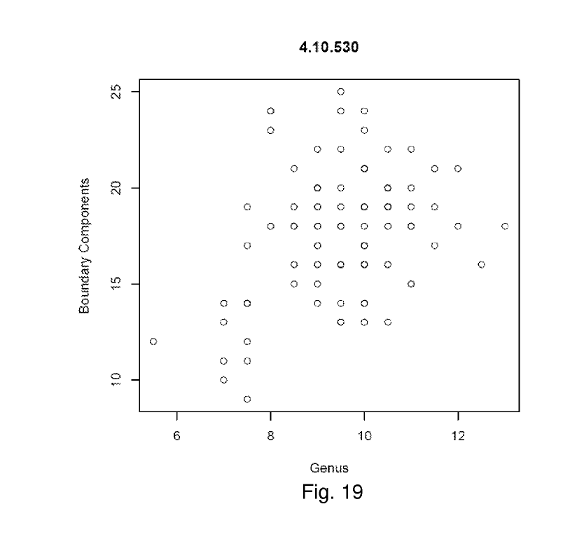

A category is fixed at some level in CATH, for example, the category 1.25, which is depicted in the FIG. 12 (captioned 1.25), consisting of alpha horseshoes, where the prefix 1 determines the alpha class, and the 25 determines the horseshoe architecture within that class. The figure plots the two invariants g* and r in with three different legends (circle, triangle and plus) in the graph, corresponding to the three possible topologies for alpha horseshoes and shows clearly that the genus and number of boundary components distinguish between these three topologies since the data of common legends are clustered together. Of course, there are standard statistical techniques to quantify this clustering to be employed, but the results are sufficiently striking that in the following data will simply be plotted and qualitatively remark on the clustering, which shows that the simplest invariants of this method, namely, g* and r, already reproduce significant aspects of the CATH classification.

FIG. 13 (captioned 1.25.40) is the diagram for 1.25.40 depicting the topology Serine Threonine Protein Phosphatase 5, Tetratricopeptide repeat of the alpha horseshoe, which corresponds the circles in FIG. 13 (1.25). This CAT-class in CATH is comprised of 19 homology classes corresponding to the 19 different legends in FIG. 13. The clustering phenomenon and the consequent conclusion that these methods capture aspects of CATH discussed before, is again manifest in the diagram for 1.25.40. Further examples on the CA and CAT levels of CATH are illustrated in FIG. 14 showing diagrams for 2.70 distorted beta sandwich, in FIG. 15 for 2.40.128 Lipocalin topology in the beta barrel architecture, in FIG. 16 for 3.20 alpha beta barrel and in FIG. 17 for 3.40.30 Glutaredoxin topology in the aba sandwich architecture.

Of the 932 plots derived from CATH in this way, most of them show this same characteristic behaviour at the CA and especially the CAT levels. Some do not, however, as will be discussed, but it is amazing at the extent to which the most basic invariants g* and r reproduce CATH in this sense of clustering of similar legends.

Before turning to a discussion of examples without the desired clustering, the class of diagrams typified by FIGS. 18 and 19 are first discussed. They number 761 of the 932 and correspond to categories where CATH does not distinguish between exemplars and provides only a unique immediate subclass. Two typical examples are given in the diagrams for 2.60.130 (FIG. 18), Protocatechuate 3,4-Dioxygenase, sub-unit A topology of the sandwich architecture, and for 4.10.530 (FIG. 19), the Gamma-brinogen Carboxyl Terminal Fragment, domain 2 topology of the common architecture of all class 4 sparse alpha beta proteins, denoted 4.10. The diagram for 2.60.130 (FIG. 18) clearly demonstrates that there are several different families of these proteins, corresponding since there are several different agglomerations of data points. Again, this can be made precise with standard statistical tests, but the phenomenon is again striking from the diagram in FIG. 18. This is a distinction that CATH fails to make, so methods described herein evidently not only reproduce aspects of the CATH classification as discussed before, but also refine it. The diagram for 4.10.530 (FIG. 19) is rather different with no significant clustering of results, but nevertheless, one important aspect of the method according to the invention, is that these proteins can still be classified precisely by their values of g* and r, thus giving an analytical refinement of CATH.

To be sure, there are multi-color examples, e.g., 1, 2, 3, 1.10, 1.20 and others, that do not exhibit the characteristic clustering of color. A crucial point is that the experiments here have only relied on the crudest topological invariants of the surface, its modified genus and number of boundary components. There are literally thousands of other descriptors arising from fatgraph properties that can and have been used to distinguish within these classes. Even the crude topological invariants have the interesting refinement of a dependence on energy, i.e., add to the backbone only those hydrogen bonds whose energies lie in some particular range and calculate the genus and number of boundary components of the resulting surface; this embodiment is further discussed later.

The inexorable conclusion from these results is that the methods of the present invention remarkably well reproduce and refine significant aspects of CATH. At the same time, taking the invariants such as g* and r as a starting point, revisions and extensions of CATH will surely add new tools for the important problem of classifying, understanding and manipulating protein globules with the similar comment for full protein molecules by applying these same techniques to the PDB.

### Example of Another Embodiment of the Invention

Instead of using the displacement vectors, the conformational angles along the backbone can be provided as input to the method. The inputs are then:
i) the primary structure given as a sequence Rᵢ of letters in the 20-letter alphabet of amino and imino acid residues, for i=1, . . . , L,
ii) the conformational angles φᵢ, ψᵢ along the backbone at the i'th residue, for i=1, . . . , L,
iii) the determination of hydrogen bonding among {Hᵢ, Oᵢ: i=1, . . . , L} described as a collection B of pairs (hⱼ, oⱼ) indicating that Hₕ_{_{—}}ⱼ is bonded to Oₒⱼ, where hⱼ, oⱼ belong to {1, . . . , L} and j=1, . . . , B.

Determining the fatgraph associated with the protein involves similar steps as described in the preferred embodiment of the invention, however step b) is different.

Suppose inductively that the configurations cᵢ∈{±} have been determined for i<I≦L. Assuming first a trans configuration in peptide units i−1 and i as specified by inputs i) and ii), the determination of the configuration c_{I} is calculated from the configuration c_{I-1} and the conformational angles φ=φ_{I}, and ψ=ψ_{I} given as input ii) as follows. Define three-by-three matrices

$${M}_{1} = A ( \begin{matrix}- sin ψ & \frac{\sqrt{3}}{2} cos ψ & - \frac{1}{2} cos ψ \\ cos ψ & \frac{\sqrt{3}}{2} sin ψ & - \frac{1}{2} sin ψ \\ 0 & - \frac{1}{2} & - \frac{\sqrt{3}}{2}\end{matrix} ) ( \begin{matrix}1 & 0 & 0 \\ 0 & - \frac{1}{2} & - \frac{\sqrt{3}}{2} \\ 0 & \frac{\sqrt{3}}{2} & - \frac{1}{2}\end{matrix} )$$

$${M}_{2} = A ( \begin{matrix}sin ψ & \frac{\sqrt{3}}{2} cos ψ & \frac{1}{2} cos ψ \\ - cos ψ & \frac{\sqrt{3}}{2} sin ψ & \frac{1}{2} sin ψ \\ 0 & - \frac{1}{2} & \frac{\sqrt{3}}{2}\end{matrix} ) ( \begin{matrix}1 & 0 & 0 \\ 0 & - \frac{1}{2} & - \frac{\sqrt{3}}{2} \\ 0 & \frac{\sqrt{3}}{2} & - \frac{1}{2}\end{matrix} )$$

where

$$A = ( \begin{matrix}- sin ϕ & - cos ϕ & 0 \\ cos ϕ & - sin ϕ & 0 \\ 0 & 0 & 1\end{matrix} ) ( \begin{matrix}\frac{1}{3} & 0 & \frac{2 \sqrt{2}}{3} \\ 0 & 1 & 0 \\ \frac{2 \sqrt{2}}{3} & 0 & \frac{1}{3}\end{matrix} )$$

and finally define

$${c}_{l} = \{ \begin{matrix}{c}_{l - 1} , & if trace ( {M}_{1} ) < trace ( {M}_{1} ) \\ - {c}_{l - 1} , & if trace ( {M}_{1} ) < trace ( {M}_{1} )\end{matrix}$$

The explanation for this determination comes from advanced geometry. The plane of the (I−1)st peptide unit determines a frame ℑ in Euclidean three-space comprised of the unit displacement vector \vec{r} from C_{I-1} to N_{I}, the unit normal \vec{n} to the plane of the peptide unit, which is determined by c_{I-1}, and the cross product \vec{r}×\vec{n}. There are likewise two frames ℑ₁, ℑ₂ corresponding to the i'th peptide unit depending upon the choice between the two possible unit normals. There are unique elements g₁, g₂ of the Lie group SO(3) respectively taking ℑ to ℑ₁ and ℑ₂. The determination above corresponds to choosing the element g₁, g₂ closest to the identity under the unique bi-invariant metric on SO(3). This is the preferred embodiment we shall employ here. As an aside, we note that an alternative (but possibly less desirable) specification of configurations is given by

$${c}_{l} = \{ \begin{matrix}{c}_{l - 1} , & if \vert ϕ - ψ \vert < 90 ° \\ - {c}_{l - 1} , & if \vert ϕ - ψ \vert > 90 °\end{matrix}$$

and still further such determinations are also of possible utility.

One reason that these alternatives are less desirable is the experimental uncertainty in conformational angles, which turn out to be plus or minus 10-15 degrees. Atomic locations turn out to have experimental uncertainty of plus or minus 0.2 angstroms, which is likewise rather large compared to the approximately 1.5 angstroms bond lengths along the backbone. One advantage of the specification of configurations based on 3-frames in the previously discussed embodiment is that because of the actual molecular modelling from the electron cloud data of X-ray crystallography, the unit displacement vectors of neighbouring atoms along the backbone are significantly better determined. Another advantage is that input consisting of non-contiguous sequences along the backbone present no difficulty. Nevertheless, the results of experiments with this embodiment are quite similar to the results of the previously discussed embodiment.

### Example of Yet Another Embodiment of the Invention

The full model for proteins or protein globules with varying bifurcation parameters and energy thresholds that allows non-contiguous data is finally discussed in detail. At the same time, this self-contained and more mathematical presentation begins tabula rasa and includes complete proofs of all of the assertions before as well as further explicit details of related material including, for example, those robust descriptors that can meaningfully be associated to a protein or protein globule, and the role of fatgraph libraries in protein structure prediction from primary structure using neural networks.

### Other Examples

This application claims priority from U.S. Provisional Application No. 61/077,277. Pages 49-82 in this document describe further examples relating to the present invention. Pages 49-82 of U.S. Provisional Application No. 61/077,277 are hereby incorporated by reference.

1-39. (canceled)

40. A method for providing a model of a molecule by means of a graph, comprising the steps of:
a) providing a graph, said graph comprising vertices and edges, each edge having a specific type, and said graph having cyclic orderings on the half-edges about at least one of the vertices,
b) obtaining the spatial coordinates and the relative spatial location of the constituent atoms of the molecule,
c) determining cyclic orderings on the half-edges about said at least one vertex by means of the spatial coordinates of the constituent atoms of the molecule,
d) determining the type of each edge of the graph by means of the relative spatial location of the constituent atoms of the molecule, and
e) modeling the molecule by the resulting graph.

41. The method according to claim 40, wherein the molecule is represented by a concatenation of at least two sub-molecules.

42. The method according to claim 40, wherein the graph comprises a sequence of subgraph building blocks, each subgraph building block representing a sub-molecule.

43. The method according to claim 42, wherein each subgraph building block comprises a horizontal line segment and a vertical line segment attached on each side of the horizontal line segment, each horizontal and vertical line segment representing a chemical bond between constituent atoms of the molecule.

44. The method according to claim 42, further comprising the steps of:
a) correlating the position of the first subgraph building block with the spatial coordinates of constituent atoms of the first sub-molecule,
b) connecting the subgraph building blocks in series based upon the relative spatial coordinates of constituent atoms comprising the sub-molecules, and
c) providing edges to the graph by connecting segments of the subgraph building blocks, each such edge corresponding to a chemical bond of the molecule.

45. The method according to claim 42, wherein each subgraph building block comprises a horizontal line segment, said horizontal line segment representing a carbon—nitrogen bond, and a vertical line segment attached on each side of the horizontal line segment, the first and leftmost vertical line segment representing an oxygen site, said method furthermore comprising the steps of
a) correlating the position of the first and leftmost vertical line segment of each subgraph building block with the orientation of the oxygen atom on the backbone of the sub-molecule,
b) connecting the horizontal segments of the subgraph building blocks in series based upon the relative spatial coordinates of constituent atoms comprising the sub-molecules, and
c) providing edges to the graph by connecting vertical segments, each edge corresponding to a hydrogen bond along the backbone of the molecule.

46. The method according to claim 40, wherein the molecule is a macromolecule, a binary macromolecule, a non-binary macromolecule, a protein, a protein globule, a ligand, a linear polymer, a nucleotide, a nucleic acid, RNA, mRNA, rRNA, tRNA, DNA or fragments thereof.

47. The method according to claim 42, wherein the molecule is a protein and the sequence of the subgraph building blocks is determined by the primary structure of the protein.

48. The method according to claim 42, wherein the subgraph building blocks represent peptide units.

49. The method according to claim 40, wherein the molecule is a protein or protein globule and wherein the relative spatial coordinates of constituent atoms and/or the conformational angles and/or the hydrogen bonding along the backbone are determined by and/or inferred from the tertiary structure of the protein.

50. The method according to claim 40, wherein the molecule is a protein or protein globule, said method providing a labelling by amino acid residues based upon the primary structure of the protein of certain edges of the graph.

51. The method according to claim 40 whereby numerical and/or other descriptors of the molecule are provided from properties of the graph.

52. The method according to claim 40 whereby it is determined whether two molecules are similar based upon equality and/or similarity of the corresponding graphs and/or descriptors.

53. The method according to claim 40, comprising the further step of providing a library of structures for a family of molecules based upon the corresponding graphs and/or descriptors.

54. The method according to claim 40, comprising the further step of identifying families of molecules based upon equality and/or similarity of the corresponding graphs.

55. The method according to claim 40, comprising the further step of providing a classification of a molecule within a family based upon the corresponding graph.

56. The method according to claim 40, comprising the further step of identifying the biological function of a molecule based upon the corresponding graph.

57. The method according to claim 40, comprising the further step of determining the melting and/or folding pathway of a molecule based upon the corresponding graph.

58. The method according to claim 40, comprising the further step of determining the secondary and/or tertiary structure of a molecule from its primary structure based upon libraries and/or descriptors provided from the corresponding graph.

59. The method according to claim 40, comprising the further step of determining the external surface and/or the active sites of a molecule from its primary structure based upon libraries and/or descriptors provided from the corresponding graph.

60. A system for providing a model of a molecule by means of a graph, said system comprising:
a graph comprising vertices and edges, each edge having a specific type, and said graph having cyclic orderings on the half-edges about at least one of the vertices,
means for obtaining the spatial coordinates and the relative spatial location of the constituent atoms of the molecule,
means for determining cyclic orderings on the half-edges about said at least one vertex by means of the spatial coordinates of the constituent atoms of the molecule,
means for determining the type of each edge of the graph by means of the relative spatial location of the constituent atoms of the molecule, and
means for modelling the molecule by the resulting graph.

61. The system according to claim 60 wherein the molecule is represented by a concatenation of at least two sub-molecules.

62. The system according to claim 60, wherein the graph comprises a sequence of subgraph building blocks, each subgraph building block representing a sub-molecule.

63. The system according to claim 62, wherein each subgraph building block comprises a horizontal line segment and a vertical line segment attached on each side of the horizontal line segment, each horizontal and vertical line segment representing a chemical bond between constituent atoms of the molecule.

64. The system according to claim 62 further comprising:
means for correlating the position of the first subgraph building block with the spatial coordinates of constituent atoms of the first sub-molecule,
means for connecting the subgraph building blocks in series based upon the relative spatial coordinates of constituent atoms comprising the sub-molecules, and
means for providing edges to the graph by connecting segments of the subgraph building blocks, each such edge corresponding to a chemical bond of the molecule.

65. The system according to claim 62, wherein each subgraph building block comprises a horizontal line segment, said horizontal line segment representing a carbon—nitrogen bond, and a vertical line segment attached on each side of the horizontal line segment, the first and leftmost vertical line segment representing an oxygen site, said system furthermore comprising:
means for correlating the position of the first and leftmost vertical line segment of each subgraph building block with the orientation of the oxygen atom on the backbone of the sub-molecule,
means for connecting the horizontal segments of the subgraph building blocks in series based upon the relative spatial coordinates of constituent atoms comprising the sub-molecules, and
means for providing edges to the graph by connecting vertical segments, each edge corresponding to a hydrogen bond along the backbone of the molecule.

66. The system according to claim 60, wherein the molecule is a macromolecule, a binary macromolecule, a non-binary macromolecule, a protein, a protein globule, a ligand, a linear polymer, a nucleotide, a nucleic acid, RNA, mRNA, rRNA, tRNA, DNA or fragments thereof.

67. The system according to claim 62, wherein the molecule is a protein and the sequence of the subgraph building blocks is determined by the primary structure of the protein.

68. The system according to claim 62 wherein the subgraph building blocks represent peptide units.

69. The system according to claim 60, wherein the molecule is a protein or protein globule and wherein the relative spatial coordinates of constituent atoms and/or the conformational angles and/or the hydrogen bonding along the backbone are determined by and/or inferred from the tertiary structure of the protein.

70. The system according to claim 60, wherein the molecule is a protein or protein globule, said method providing a labelling by amino acid residues based upon the primary structure of the protein of certain edges of the graph.

71. A computer usable medium having computer-readable program code means providing a system for providing a model of a molecule by means of a graph, said graph comprising vertices and edges, each edge having a specific type, and said graph having cyclic orderings on the half-edges about at least one of the vertices, said computer-readable program code comprising:
computer program code means for obtaining the spatial coordinates and the relative spatial location of the constituent atoms of the molecule,
computer program code means for determining cyclic orderings on the half-edges about said at least one vertex by means of the spatial coordinates of the constituent atoms of the molecule,
computer program code means for determining the type of each edge of the graph by means of the relative spatial location of the constituent atoms of the molecule, and
computer program code means for modelling the molecule by the resulting graph.

72. A method for providing a model of a peptide unit, said model comprising a horizontal line segment representing the carbon—nitrogen bond and a vertical line segment attached on each side of the horizontal line segment, the first and leftmost vertical line segment representing an oxygen site, wherein the relative position of the first and leftmost vertical line segment corresponds to the location of the oxygen atom on the backbone of the peptide unit when traversed in its natural orientation from the nitrogen end to the carbon end, and
wherein the second and rightmost vertical line segment represents a hydrogen site, or
wherein the second and rightmost vertical line segment represents a carbon site.
